(19) United States
(12) Patent Application Publication
(10) Pub. No.: US 2024/0150587 A1
(43) Pub. Date: May 9, 2024

(54) CORROSION INHIBITING COATINGS COMPRISING ALUMINUM PARTICLES, MAGNESIUM OXIDE AND AN ALUMINUM AND/OR IRON COMPOUND

(71) Applicant: PRC-Desoto International, Inc., Sylmar, CA (US)

(72) Inventors: Victor Franklin Georgic, Pittsburgh, PA (US); Megan Elizabeth Ferlic, Mars, PA (US); Justin Jonathan Martin, Harrison City, PA (US)

(73) Assignee: PRC-Desoto International, Inc., Sylmar, CA (US)

(21) Appl. No.: 18/548,340

(22) PCT Filed: Dec. 30, 2021
(86) PCT No.: PCT/US2021/065779

§ 371 Date: Aug. 30, 2023

Related U.S. Application Data
(60) Provisional application No. 63/155,571, filed on Mar. 2, 2021.

(51) Int. Cl. C09D 5/10; C09D 7/61; C09D 163/00

(52) U.S. Cl. CPC C09D 5/103; C09D 7/61; C09D 163/00; C08K 2003/0812

(57) ABSTRACT

The present invention is directed to a coated metal substrate comprising a metal substrate; and a coating applied over at least a portion of the metal substrate, wherein the coating comprises a film-forming binder; magnesium oxide; an aluminum compound and/or iron compound; and aluminum particles. The present invention also provides a curable film-forming coating composition comprising a film-forming binder; magnesium oxide; an aluminum and/or iron compound; and aluminum particles. Also disclosed are methods of coating a substrate.

### FIELD OF THE INVENTION

The present invention is directed towards corrosion inhibiting coatings, coating compositions, methods of coating substrates, and coated substrates.

### BACKGROUND OF THE INVENTION

Coatings are applied to appliances, automobiles, aircraft, and the like for a number of reasons, most notably for aesthetic reasons, corrosion protection and/or enhanced performance such as durability and protection from physical damage. To improve the corrosion resistance of a metal substrate, corrosion inhibitors may be used in the coatings applied to the substrate. However, evolving government regulations in view of health and environmental concerns have led to the phasing out of certain corrosion inhibitors and other additives in coating compositions, making the production of effective coating compositions challenging.

It would be desirable to provide suitable coating compositions that demonstrate desired levels of corrosion resistance using corrosion inhibitors acceptable from a health and environmental perspective.

### SUMMARY OF THE INVENTION

The present invention provides a coated metal substrate comprising a metal substrate; and a coating applied over at least a portion of the metal substrate, wherein the coating comprises a film-forming binder; magnesium oxide; an aluminum compound and/or iron compound; and aluminum particles.

The present invention also provides a curable film-forming coating composition comprising a film-forming binder; magnesium oxide; an aluminum and/or iron compound; and aluminum particles.

The present invention further provides a method of coating a metal substrate comprising applying a curable film-forming coating composition comprising a film-forming binder; magnesium oxide; an aluminum and/or iron compound; and aluminum particles to at least a portion of the substrate to form a coating.

### DETAILED DESCRIPTION OF THE INVENTION

The present invention is directed to a coated metal substrate comprising a metal substrate; and a coating applied over at least a portion of the metal substrate, wherein the coating comprises a film-forming binder; magnesium oxide; an aluminum compound and/or iron compound; and aluminum particles.

The present invention is also directed to a curable film-forming coating composition comprising a film-forming binder; magnesium oxide; an aluminum and/or iron compound; and aluminum particles. The curable film-forming coating composition may be used to form the coated metal substrate of the present invention.

### Film-Forming Binder

The coating and/or curable film-forming coating composition of the present invention comprises a film-forming binder. As discussed further below, the film-forming binder of the coating composition of the present invention is not limited and may comprise any curable, film-forming binder.

As used herein, the term “curable” and like terms refers to compositions that undergo a reaction in which they “set” irreversibly, such as when the components of the composition react with each other and the polymer chains of the polymeric components are joined together by covalent bonds. This property is usually associated with a crosslinking reaction of the composition constituents often induced, for example, by heat or radiation. See Hawley, Gessner G., The Condensed Chemical Dictionary, Ninth Edition., page 856; Surface Coatings, vol. 2, Oil and Colour Chemists' Association, Australia, TAFE Educational Books (1974). Curing or crosslinking reactions also may be carried out under ambient conditions. By ambient conditions is meant that the coating undergoes a thermosetting reaction without the aid of heat or other energy, for example, without baking in an oven, use of forced air, or the like. Usually ambient temperature ranges from 60 to 90° F. (15.6 to 32.2° C.), such as a typical room temperature, 72° F. (22.2° C.). Once cured or crosslinked, a thermosetting resin will not melt upon the application of heat and is insoluble in solvents.

The film-forming binder may comprise (a) a resin component comprising reactive functional groups; and (b) a curing agent component comprising functional groups that are reactive with the functional groups in the resin component (a), although the film-forming binder component may also contain resin that will crosslink with itself rather than (or in addition to) an additional curing agent (i.e., self-crosslinking).

The resin component (a) used in the film-forming binder component of the curable film-forming compositions of the present invention may comprise one or more of acrylic polymers, polyesters, polyurethanes, polyamides, polyethers, polythioethers, polythioesters, polythiols, polyenes, polyols, polysilanes, polysiloxanes, fluoropolymers, polycarbonates, and epoxy resins. Generally these compounds, which need not be polymeric, can be made by any method known to those skilled in the art. The functional groups on the film-forming binder may comprise at least one of carboxylic acid groups, amine groups, epoxide groups, hydroxyl groups, thiol groups, carbamate groups, amide groups, urea groups, (meth)acrylate groups, styrenic groups, vinyl groups, allyl groups, aldehyde groups, acetoacetate groups, hydrazide groups, cyclic carbonate, ketone groups, carbodiimide groups, oxazoline groups, alkoxy-silane functional groups, isocyanato functional groups, and maleic acid or anhydride groups. The functional groups on the film-forming binder are selected so as to be reactive with those on the curing agent (b) or to be self-crosslinking. As used herein, the term “polymer” encompasses, but is not limited to, oligomers and both homopolymers and copolymers.

Suitable acrylic compounds include copolymers of one or more alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, and often 4 to 18 carbon atoms in the alkyl group. Non-limiting examples include methyl methacrylate, ethyl methacrylate, butyl methacrylate, ethyl acrylate, butyl acrylate, and 2-ethyl hexyl acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

The acrylic copolymer can include hydroxyl functional groups, which are often incorporated into the polymer by including one or more hydroxyl functional monomers in the reactants used to produce the copolymer. Useful hydroxyl functional monomers include hydroxyalkyl acrylates and methacrylates, typically having 2 to 4 carbon atoms in the hydroxyalkyl group, such as hydroxyethyl acrylate, hydroxypropyl acrylate, 4-hydroxybutyl acrylate, hydroxy functional adducts of caprolactone and hydroxyalkyl acrylates, and corresponding methacrylates, as well as the beta-hydroxy ester functional monomers described below. The acrylic polymer can also be prepared with N-(alkoxymethyl)acrylamides and N-(alkoxymethyl)methacrylamides.

Beta-hydroxy ester functional monomers can be prepared from ethylenically unsaturated, epoxy functional monomers and carboxylic acids having from about 13 to about 20 carbon atoms, or from ethylenically unsaturated acid functional monomers and epoxy compounds containing at least 5 carbon atoms that are not polymerizable with the ethylenically unsaturated acid functional monomer.

Useful ethylenically unsaturated, epoxy functional monomers used to prepare the beta-hydroxy ester functional monomers include glycidyl acrylate, glycidyl methacrylate, allyl glycidyl ether, methallyl glycidyl ether, 1:1 (molar) adducts of ethylenically unsaturated monoisocyanates with hydroxy functional monoepoxides such as glycidol, and glycidyl esters of polymerizable polycarboxylic acids such as maleic acid. (Note: these epoxy functional monomers may also be used to prepare epoxy functional acrylic polymers.) Examples of carboxylic acids include saturated monocarboxylic acids such as isostearic acid and aromatic unsaturated carboxylic acids.

Useful ethylenically unsaturated acid functional monomers used to prepare the beta-hydroxy ester functional monomers include monocarboxylic acids such as acrylic acid, methacrylic acid, crotonic acid; dicarboxylic acids such as itaconic acid, maleic acid and fumaric acid; and monoesters of dicarboxylic acids such as monobutyl maleate and monobutyl itaconate. The ethylenically unsaturated acid functional monomer and epoxy compound are typically reacted in a 1:1 equivalent ratio. The epoxy compound does not contain ethylenic unsaturation that would participate in free radical-initiated polymerization with the unsaturated acid functional monomer. Useful epoxy compounds include 1,2-pentene oxide, styrene oxide and glycidyl esters or ethers, often containing from 8 to 30 carbon atoms, such as butyl glycidyl ether, octyl glycidyl ether, phenyl glycidyl ether and para-(tertiary butyl) phenyl glycidyl ether. Particular glycidyl esters include those of the structure:

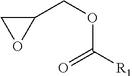

where R₁ is a hydrocarbon radical containing from about 4 to about 26 carbon atoms. Typically, R is a branched hydrocarbon group having from about 8 to about 10 carbon atoms, such as neopentanoate, neoheptanoate or neodecanoate. Suitable glycidyl esters of carboxylic acids include VERSATIC ACID 911 and CARDURA E, each of which is commercially available from Shell Chemical Co.

Carbamate functional groups can be included in the acrylic polymer by copolymerizing the acrylic monomers with a carbamate functional vinyl monomer, such as a carbamate functional alkyl ester of methacrylic acid, or by reacting a hydroxyl functional acrylic polymer with a low molecular weight carbamate functional material, such as can be derived from an alcohol or glycol ether, via a transcarbamoylation reaction. In this reaction, a low molecular weight carbamate functional material derived from an alcohol or glycol ether is reacted with the hydroxyl groups of the acrylic polyol, yielding a carbamate functional acrylic polymer and the original alcohol or glycol ether. The low molecular weight carbamate functional material derived from an alcohol or glycol ether may be prepared by reacting the alcohol or glycol ether with urea in the presence of a catalyst. Suitable alcohols include lower molecular weight aliphatic, cycloaliphatic, and aromatic alcohols such as methanol, ethanol, propanol, butanol, cyclohexanol, 2-ethylhexanol, and 3-methylbutanol. Suitable glycol ethers include ethylene glycol methyl ether and propylene glycol methyl ether. Propylene glycol methyl ether and methanol are most often used. Other carbamate functional monomers as known to those skilled in the art may also be used.

Amide functionality may be introduced to the acrylic polymer by using suitably functional monomers in the preparation of the polymer, or by converting other functional groups to amido-groups using techniques known to those skilled in the art. Likewise, other functional groups may be incorporated as desired using suitably functional monomers if available or conversion reactions as necessary.

Acrylic polymers can be prepared via aqueous emulsion polymerization techniques and used directly in the preparation of aqueous coating compositions or can be prepared via organic solution polymerization techniques for solventborne compositions. When prepared via organic solution polymerization with groups capable of salt formation such as acid or amine groups, upon neutralization of these groups with a base or acid the polymers can be dispersed into aqueous medium. Generally, any method of producing such polymers that is known to those skilled in the art utilizing art recognized amounts of monomers can be used.

The resin component (a) in the film-forming binder component of the curable film-forming composition may comprise an alkyd resin or a polyester. Such polymers may be prepared in a known manner by condensation of polyhydric alcohols and polycarboxylic acids. Suitable polyhydric alcohols include, but are not limited to, ethylene glycol, propylene glycol, butylene glycol, 1,6-hexylene glycol, neopentyl glycol, diethylene glycol, glycerol, trimethylol propane, and pentaerythritol. Suitable polycarboxylic acids include, but are not limited to, succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used. Where it is desired to produce air-drying alkyd resins, suitable drying oil fatty acids may be used and include, for example, those derived from linseed oil, soya bean oil, tall oil, dehydrated castor oil, or tung oil.

Likewise, polyamides may be prepared utilizing polyacids and polyamines. Suitable polyacids include those listed above and polyamines may be comprise, for example, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane.

Carbamate functional groups may be incorporated into the polyester or polyamide by first forming a hydroxyalkyl carbamate which can be reacted with the polyacids and polyols/polyamines used in forming the polyester or polyamide. The hydroxyalkyl carbamate is condensed with acid functionality on the polymer, yielding terminal carbamate functionality. Carbamate functional groups may also be incorporated into the polyester by reacting terminal hydroxyl groups on the polyester with a low molecular weight carbamate functional material via a transcarbamoylation process similar to the one described above in connection with the incorporation of carbamate groups into the acrylic polymers, or by reacting isocyanic acid with a hydroxyl functional polyester.

Other functional groups such as amine, amide, thiol, urea, or others listed above may be incorporated into the polyamide, polyester or alkyd resin as desired using suitably functional reactants if available, or conversion reactions as necessary to yield the desired functional groups. Such techniques are known to those skilled in the art.

Polyurethanes can also be used as the resin component (a) in the film-forming binder component of the curable film-forming composition. Among the polyurethanes that can be used are polymeric polyols, which generally are prepared by reacting the polyester polyols or acrylic polyols such as those mentioned above with a polyisocyanate such that the OH/NCO equivalent ratio is greater than 1:1 so that free hydroxyl groups are present in the product. The organic polyisocyanate that is used to prepare the polyurethane polyol can be an aliphatic or an aromatic polyisocyanate or a mixture of the two. Diisocyanates are typically used, although higher polyisocyanates can be used in place of or in combination with diisocyanates. Examples of suitable aromatic diisocyanates are 4,4′-diphenylmethane diisocyanate and toluene diisocyanate. Examples of suitable aliphatic diisocyanates are straight chain aliphatic diisocyanates such as 1,6-hexamethylene diisocyanate. Also, cycloaliphatic diisocyanates can be employed. Examples include isophorone diisocyanate and 4,4′-methylene-bis-(cyclohexyl isocyanate). Examples of suitable higher polyisocyanates are 1,2,4-benzene triisocyanate polymethylene polyphenyl isocyanate, and isocyanate trimers based on 1,6-hexamethylene diisocyanate or isophorone diisocyanate. As with the polyesters, the polyurethanes can be prepared with unreacted carboxylic acid groups, which, upon neutralization with bases such as amines, allows for dispersion into aqueous medium.

Terminal and/or pendent carbamate functional groups can be incorporated into the polyurethane by reacting a polyisocyanate with a polymeric polyol containing the terminal/pendent carbamate groups. Alternatively, carbamate functional groups can be incorporated into the polyurethane by reacting a polyisocyanate with a polyol and a hydroxyalkyl carbamate or isocyanic acid as separate reactants. Carbamate functional groups can also be incorporated into the polyurethane by reacting a hydroxyl functional polyurethane with a low molecular weight carbamate functional material via a transcarbamoylation process similar to the one described above in connection with the incorporation of carbamate groups into the acrylic polymer. Additionally, an isocyanate functional polyurethane can be reacted with a hydroxyalkyl carbamate to yield a carbamate functional polyurethane.

Other functional groups such as amide, thiol, urea, or others listed above may be incorporated into the polyurethane as desired using suitably functional reactants if available, or conversion reactions as necessary to yield the desired functional groups. Such techniques are known to those skilled in the art.

Examples of polyether polyols are polyalkylene ether polyols which include those having the following structural formula:

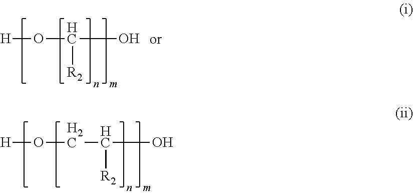

where the substituent R₂ is hydrogen or lower alkyl containing from 1 to 5 carbon atoms including mixed substituents, n is typically from 2 to 6 and m is from 8 to 100 or higher. Included are poly(oxytetramethylene) glycols, poly(oxytetraethylene) glycols, poly(oxy-1,2-propylene) glycols, and poly(oxy-1,2-butylene) glycols.

Also useful are polyether polyols formed from oxyalkylation of various polyols, for example, diols such as ethylene glycol, 1,6-hexanediol, Bisphenol A and the like, or other higher polyols such as trimethylolpropane, pentaerythritol, and the like. Polyols of higher functionality which can be utilized as indicated can be made, for instance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst. Particular polyethers include those sold under the names TERATHANE and TERACOL, available from The Lycra Company, and POLYMEG, available from LyondellBasell.

Carbamate functional groups may be incorporated into the polyethers by a transcarbamoylation reaction. Other functional groups such as acid, amine, epoxide, amide, thiol, and urea may be incorporated into the polyether as desired using suitably functional reactants if available, or conversion reactions as necessary to yield the desired functional groups. Examples of suitable amine functional polyethers include those sold under the name JEFFAMINE, such as JEFFAMINE D2000, a polyether functional diamine available from Huntsman Corporation.

Suitable epoxy functional polymers for use as the resin component (a) may include a polyepoxide chain extended by reacting together a polyepoxide and a polyhydroxyl group-containing material selected from alcoholic hydroxyl group-containing materials and phenolic hydroxyl group-containing materials to chain extend or build the molecular weight of the polyepoxide.

A chain extended polyepoxide is typically prepared by reacting together the polyepoxide and polyhydroxyl group-containing material neat or in the presence of an inert organic solvent such as a ketone, including methyl isobutyl ketone and methyl amyl ketone, aromatics such as toluene and xylene, and glycol ethers such as the dimethyl ether of diethylene glycol. The reaction is usually conducted at a temperature of 80° C. to 160° C. for 30 to 180 minutes until an epoxy group-containing resinous reaction product is obtained.

The equivalent ratio of reactants, i.e., epoxy:polyhydroxyl group-containing material is typically from about 1.00:0.75 to 1.00:2.00. It will be appreciated by one skilled in the art that the chain extended polyepoxide will lack epoxide functional groups when reacted with the polyhydroxyl group-containing material such that an excess of hydroxyl functional groups are present. The resulting polymer will comprise hydroxyl functional groups resulting from the excess of hydroxyl functional groups and the hydroxyl functional groups produced by the ring-opening reaction of the epoxide functional groups.

The polyepoxide by definition has at least two 1,2-epoxy groups. In general, the epoxide equivalent weight of the polyepoxide may range from 100 to 2000, such as from 180 to 500. The epoxy compounds may be saturated or unsaturated, cyclic or acyclic, aliphatic, alicyclic, aromatic or heterocyclic. They may contain substituents such as halogen, hydroxyl, and ether groups.

Examples of polyepoxides are those having a 1,2-epoxy equivalency of one to two, such as greater than one and less than two or of two; that is, polyepoxides that have on average two epoxide groups per molecule. The most commonly used polyepoxides are polyglycidyl ethers of cyclic polyols, for example, polyglycidyl ethers of polyhydric phenols such as Bisphenol A, resorcinol, hydroquinone, benzenedimethanol, phloroglucinol, and catechol; or polyglycidyl ethers of polyhydric alcohols such as alicyclic polyols, particularly cycloaliphatic polyols such as 1,2-cyclohexane diol, 1,4-cyclohexane diol, 2,2-bis(4-hydroxycyclohexyl)propane, 1,1-bis(4-hydroxycyclohexyl)ethane, 2-methyl-1,1-bis(4-hydroxycyclohexyl)propane, 2,2-bis(4-hydroxy-3-tertiarybutylcyclohexyl)propane, 1,3-bis(hydroxymethyl)cyclohexane and 1,2-bis(hydroxymethyl)cyclohexane. Examples of aliphatic polyols include, inter alia, trimethylpentanediol and neopentyl glycol.

Polyhydroxyl group-containing materials used to chain extend or increase the molecular weight of the polyepoxide may additionally be polymeric polyols such as any of those disclosed above. The present invention may comprise epoxy resins such as diglycidyl or polyglycidyl ethers of Bisphenol A, Bisphenol F, glycerol, novolacs, and the like. Exemplary suitable polyepoxides are described in U.S. Pat. No. 4,681,811 at column 5, lines 33 to 58, the cited portion of which is incorporated by reference herein. Non-limiting examples of suitable commercially available epoxy resins include EPON 828 and EPON 1001, both available from Momentive, and D.E.N. 431 available from Dow Chemical Co.

Epoxy functional film-forming polymers may alternatively be acrylic polymers prepared with epoxy functional monomers such as glycidyl acrylate, glycidyl methacrylate, allyl glycidyl ether, and methallyl glycidyl ether. Polyesters, polyurethanes, or polyamides prepared with glycidyl alcohols or glycidyl amines, or reacted with an epihalohydrin are also suitable epoxy functional resins. Epoxide functional groups may be incorporated into a resin by reacting hydroxyl groups on the resin with an epihalohydrin or dihalohydrin such as epichlorohydrin or dichlorohydrin in the presence of alkali.

Nonlimiting examples of suitable fluoropolymers include fluoroethylene-alkyl vinyl ether alternating copolymers (such as those described in U.S. Pat. No. 4,345,057) available from Asahi Glass Company under the name LUMIFLON; fluoroaliphatic polymeric esters commercially available from 3M of St. Paul, Minnesota under the name FLUORAD; and perfluorinated hydroxyl functional (meth)acrylate resins.

The amount of film-forming resin component (a) in the curable film-forming composition may range from 10 to 90% by weight, based on the total weight of resin solids in the curable film-forming composition. For example, the film-forming resin may be present in an amount of at least 10% by weight, such as at least 20% by weight or at least 30% by weight, based on the total weight of resin solids in the curable film-forming composition. The film-forming resin may be present in an amount of no more than 90% by weight, such as no more than 80% by weight, or no more than 70% by weight, based on the total weight of resin solids in the curable film-forming composition. Ranges of the film-forming resin component may include, for example, 20 to 80% by weight, 50 to 90% by weight, 60 to 80% by weight, 25 to 75% by weight, based on the total weight of resin solids in the curable film-forming composition.

The film-forming binder may be substantially free, essentially free, or completely free of film-forming resins having acetoacetate functional groups and/or malonate functional groups. The film-forming binder is “substantially free” of film-forming resins having acetoacetate functional groups and/or malonate functional groups if such resins are present, if at all, in amount of less than 5% by weight, based on the total weight of the resin solids. The film-forming binder is “essentially free” of film-forming resins having acetoacetate functional groups and/or malonate functional groups if such resins are present, if at all, in amount of less than 1% by weight, based on the total weight of the resin solids. The film-forming binder is “completely free” of film-forming resins having acetoacetate functional groups and/or malonate functional groups if such resins are not present, i.e., 0.0% by weight, based on the total weight of the resin solids.

As used herein, the “resin solids” include the components of the film-forming binder of the coating composition. For example, the resin solids may include film-forming polymers, the curing agent, and any additional non-pigmented component(s) present in the coating composition. The resin solids expressly exclude magnesium oxide, the aluminum and/or iron compound, and any other pigment components.

### Curing Agent

According to the present invention, the film-forming binder of the curable film-forming coating composition may further comprise a curing agent (b). Suitable curing agents (b) for use in the film-forming binder component of the coating compositions of the present invention include aminoplasts, polyisocyanates, including blocked isocyanates, polyepoxides, beta-hydroxyalkylamides, polyacids, organometallic acid-functional materials, polyamines, polyamides, polysulfides, polythiols, polyenes such as polyacrylates, polyols, polysilanes and mixtures of any of the foregoing, and include those known in the art for any of these materials. The terms “curing agent” “crosslinking agent” and “crosslinker” are herein used interchangeably.

Useful aminoplasts can be obtained from the condensation reaction of formaldehyde with an amine or amide. Nonlimiting examples of amines or amides include melamine, urea and benzoguanamine.

Although condensation products obtained from the reaction of alcohols and formaldehyde with melamine, urea or benzoguanamine are most common, condensates with other amines or amides can be used. Formaldehyde is the most commonly used aldehyde, but other aldehydes such as acetaldehyde, crotonaldehyde, and benzaldehyde can also be used.

The aminoplast can contain imino and methylol groups. In certain instances, at least a portion of the methylol groups can be etherified with an alcohol to modify the cure response. Any monohydric alcohol like methanol, ethanol, n-butyl alcohol, isobutanol, and hexanol can be employed for this purpose. Nonlimiting examples of suitable aminoplast resins are commercially available from Allnex, under the trademark CYMEL and from INEOS under the trademark RESIMENE.

Other crosslinking agents suitable for use include polyisocyanate crosslinking agents. As used herein, the term “polyisocyanate” is intended to include blocked (or capped) polyisocyanates as well as unblocked polyisocyanates. The polyisocyanate can be aliphatic, aromatic, or a mixture thereof. Although higher polyisocyanates such as isocyanurates of diisocyanates are often used, diisocyanates can also be used. Isocyanate prepolymers, for example reaction products of polyisocyanates with polyols also can be used. Mixtures of polyisocyanate crosslinking agents can be used.

The polyisocyanate can be prepared from a variety of isocyanate-containing materials. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used.

Isocyanate groups may be capped or uncapped as desired. If the polyisocyanate is to be blocked or capped, any suitable aliphatic, cycloaliphatic, or aromatic alkyl monoalcohol or phenolic compound known to those skilled in the art can be used as a capping agent for the polyisocyanate. Examples of suitable blocking agents include those materials which would unblock at elevated temperatures such as lower aliphatic alcohols including methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as capping agents. Suitable glycol ethers include ethylene glycol butyl ether, diethylene glycol butyl ether, ethylene glycol methyl ether and propylene glycol methyl ether. Other suitable capping agents include oximes such as methyl ethyl ketoxime, acetone oxime and cyclohexanone oxime, lactams such as epsilon-caprolactam, pyrazoles such as dimethyl pyrazole, and amines such as dibutyl amine, butyl glycol amide, and butyl lactamide.

The crosslinking agent may optionally comprise a high molecular weight volatile group. These may be the same as discussed above. High molecular weight volatile groups may comprise 5% to 50% by weight of the film-forming binder, such as 7% to 45% by weight, such as 9% to 40% by weight, such as 11% to 35%, such as 13% to 30%, based on the total weight of the organic film-forming binder. The high molecular weight volatile groups and other lower molecular weight volatile organic compounds produced during cure, such as lower molecular weight blocking agents and organic byproducts produced during cure, may be present in an amount such that the relative weight loss of the organic film-forming binder deposited onto the substrate relative to the weight of the organic film-forming binder after cure is an amount of 5% to 50% by weight of the organic film-forming binder, such as 7% to 45% by weight, such as 9% to 40% by weight, such as 11% to 35%, such as 13% to 30%, based on the total weight of the organic film-forming binder before and after cure.

Polyepoxides are suitable curing agents for polymers having carboxylic acid groups and/or amine groups. Examples of suitable polyepoxides include low molecular weight polyepoxides such as 3,4-epoxycyclohexylmethyl 3,4-epoxycyclohexanecarboxylate and bis(3,4-epoxy-6-methylcyclohexyl-methyl) adipate. Higher molecular weight polyepoxides, including the polyglycidyl ethers of polyhydric phenols and alcohols described above, are also suitable as crosslinking agents.

Beta-hydroxyalkylamides are suitable curing agents for polymers having carboxylic acid groups. The beta-hydroxyalkylamides can be depicted structurally as follows:

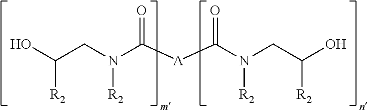

wherein each R₂ is hydrogen or lower alkyl containing from 1 to 5 carbon atoms including mixed substituents or:

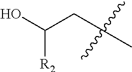

wherein R₂ is hydrogen or lower alkyl containing from 1 to 5 carbon atoms including mixed substituents; A is a bond or a polyvalent organic radical derived from a saturated, unsaturated, or aromatic hydrocarbon including substituted hydrocarbon radicals containing from 2 to 20 carbon atoms; m′ is equal to 1 or 2; n′ is equal to 0 or 2, and m′+n′ is at least 2, usually within the range of from 2 up to and including 4. Most often, A is a C₂ to C₁₂ divalent alkylene radical.

Polyacids, particularly polycarboxylic acids, are suitable curing agents for polymers having epoxy functional groups. Examples of suitable polycarboxylic acids include adipic, succinic, sebacic, azelaic, and dodecanedioic acid. Other suitable polyacid crosslinking agents include acid group-containing acrylic polymers prepared from an ethylenically unsaturated monomer containing at least one carboxylic acid group and at least one ethylenically unsaturated monomer that is free from carboxylic acid groups. Such acid functional acrylic polymers can have an acid equivalent weight ranging from 100 to 2,000 g/mol, based on the total solid weight of the acid functional acrylic polymers. Acid functional group-containing polyesters can be used as well. Low molecular weight polyesters and half-acid esters can be used that are based on the condensation of aliphatic polyols with aliphatic and/or aromatic polycarboxylic acids or anhydrides. Examples of suitable aliphatic polyols include ethylene glycol, propylene glycol, butylene glycol, 1,6-hexanediol, trimethylol propane, di-trimethylol propane, neopentyl glycol, 1,4-cyclohexanedimethanol, pentaerythritol, and the like. The polycarboxylic acids and anhydrides may include, inter alia, terephthalic acid, isophthalic acid, phthalic acid, phthalic anhydride, tetrahydrophthalic acid, tetrahydrophthalic anhydride, hexahydrophthalic anhydride, methylhexahydrophthalic anhydride, chlorendic anhydride, and the like. Mixtures of acids and/or anhydrides may also be used. The above-described polyacid crosslinking agents are described in further detail in U.S. Pat. No. 4,681,811, at column 6, line 45 to column 9, line 54, the cited portion of which is incorporated herein by reference.

Nonlimiting examples of suitable polyamine crosslinking agents include primary or secondary diamines or polyamines in which the radicals attached to the nitrogen atoms can be saturated or unsaturated, aliphatic, alicyclic, aromatic, aromatic-substituted-aliphatic, aliphatic-substituted-aromatic, and heterocyclic. Nonlimiting examples of suitable aliphatic and alicyclic diamines include 1,2-ethylene diamine, 1,2-propylene diamine, 1,8-octane diamine, isophorone diamine, propane-2,2-cyclohexyl amine, and the like. Nonlimiting examples of suitable aromatic diamines include phenylene diamines and toluene diamines, for example o-phenylene diamine and p-tolylene diamine. Polynuclear aromatic diamines such as 4,4′-biphenyl diamine, methylene dianiline and monochloromethylene dianiline are also suitable.

Examples of suitable aliphatic diamines include, without limitation, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof. Cycloaliphatic diamines are available commercially from Huntsman Corporation (Houston, TX) under the designation of JEFFLINK such as JEFFLINK 754. Additional aliphatic cyclic polyamines may also be used, such as DESMOPHEN NH 1520 available from Covestro and/or CLEARLINK 1000, which is a secondary aliphatic diamine available from Dorf Ketal. POLYCLEAR 136 (available from BASF/Hansen Group LLC), the reaction product of isophorone diamine and acrylonitrile, is also suitable. Other exemplary suitable polyamines are described in U.S. Pat. No. 4,046,729 at column 6, line 61 to column 7, line 26, and in U.S. Pat. No. 3,799,854 at column 3, lines 13 to 50, the cited portions of which are incorporated by reference herein. Additional polyamines may also be used, such as ANCAMINE polyamines, available from Evonik.

Suitable polyamides include any of those known in the art. For example, ANCAMIDE polyamides, available from Evonik.

Suitable polyenes may include those that are represented by the formula:

A-(X)ₘ

wherein A is an organic moiety, X is an olefinically unsaturated moiety and m is at least 2, typically 2 to 6. Examples of X are groups of the following structure:

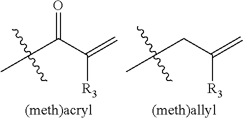

wherein each R₃ is a radical selected from H and methyl.

The polyenes may be compounds or polymers having in the molecule olefinic double bonds that are polymerizable by exposure to radiation. Examples of such materials are (meth)acrylic-functional (meth)acrylic copolymers, epoxy resin (meth)acrylates, polyester (meth)acrylates, polyether (meth)acrylates, polyurethane (meth)acrylates, amino (meth)acrylates, silicone (meth)acrylates, and melamine (meth)acrylates. The number average molar mass (Mn) of these compounds is often 200 to 10,000 as determined by GPC using polystyrene as a standard. The molecule often contains on average 2 to 20 olefinic double bonds that are polymerizable by exposure to radiation. Aliphatic and/or cycloaliphatic (meth)acrylates in each case are often used. (Cyclo)aliphatic polyurethane (meth)acrylates and (cyclo)aliphatic polyester (meth)acrylates are particularly suitable. The binders may be used singly or in mixture.

Specific examples of polyurethane (meth)acrylates are reaction products of the polyisocyanates such as 1,6-hexamethylene diisocyanate and/or isophorone diisocyanate including isocyanurate and biuret derivatives thereof with hydroxyalkyl (meth)acrylates such as hydroxyethyl (meth)acrylate and/or hydroxypropyl (meth)acrylate. The polyisocyanate can be reacted with the hydroxyalkyl (meth)acrylate in a 1:1 equivalent ratio or can be reacted with an NCO/OH equivalent ratio greater than 1 to form an NCO-containing reaction product that can then be chain extended with a polyol such as a diol or triol, for example, 1,4-butane diol, 1,6-hexane diol and/or trimethylol propane. Examples of polyester (meth)acrylates are the reaction products of (meth)acrylic acid or anhydride with polyols, such as diols, triols and tetrols, including alkylated polyols, such as propoxylated diols and triols. Examples of polyols include 1,4-butane diol, 1,6-hexane diol, neopentyl glycol, trimethylol propane, pentaerythritol and propoxylated 1,6-hexane diol. Specific examples of polyester (meth)acrylate are glycerol tri(meth)acrylate, trimethylolpropane tri(meth)acrylate, pentaerythritol tri(meth)acrylate and pentaerythritol tetra(meth)acrylate.

Besides (meth)acrylates, (meth)allyl compounds or polymers can be used either alone or in combination with (meth)acrylates. Examples of (meth)allyl materials are polyallyl ethers such as the diallyl ether of 1,4-butane diol and the triallyl ether of trimethylol propane. Examples of other (meth)allyl materials are polyurethanes containing (meth)allyl groups. For example, reaction products of the polyisocyanates such as 1,6-hexamethylene diisocyanate and/or isophorone diisocyanate including isocyanurate and biuret derivatives thereof with hydroxyl-functional allyl ethers, such as the monoallyl ether of 1,4-butane diol and the diallylether of trimethylol propane. The polyisocyanate can be reacted with the hydroxyl-functional allyl ether in a 1:1 equivalent ratio or can be reacted with an NCO/OH equivalent ratio greater than 1 to form an NCO-containing reaction product that can then be chain extended with a polyol such as a diol or triol, for example, 1,4-butane diol, 1,6-hexane diol and/or trimethylol propane.

As used herein the term “polythiol functional material” refers to polyfunctional materials containing two or more thiol functional groups (SH). Suitable polythiol functional materials for use in forming the curable film-forming composition are numerous and can vary widely. Such polythiol functional materials can include those that are known in the art. Non-limiting examples of suitable polythiol functional materials can include polythiols having at least two thiol groups including compounds and polymers. The polythiol can have ether linkages (—O—), sulfide linkages (—S—), including polysulfide linkages (—Sₓ—), wherein x is at least 2, such as from 2 to 4, and combinations of such linkages.

The polythiols for use in the present invention include materials of the formula:

R₄—(SH)_{n′}

wherein R₄ is a polyvalent organic moiety and n′ is an integer of at least 2, typically 2 to 6.

Non-limiting examples of suitable polythiols include esters of thiol-containing acids of the formula HS—R₅—COOH wherein R₅ is an organic moiety with polyhydroxy compounds of the structure R₆—(OH)ₙ wherein R₆ is an organic moiety and n′ is at least 2, typically 2 to 6. These components can be reacted under suitable conditions to give polythiols having the general structure:

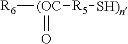

wherein R₅, R₆ and n′ are as defined above.

Examples of thiol-containing acids are thioglycolic acid (HS—CH₂COOH), α-mercaptopropionic acid (HS—CH(CH₃)—COOH) and β-mercaptopropionic acid (HS—CH₂CH₂COOH) with polyhydroxy compounds such as glycols, triols, tetrols, pentaols, hexaols, and mixtures thereof. Other non-limiting examples of suitable polythiols include ethylene glycol bis (thioglycolate), ethylene glycol bis(β-mercaptopropionate), trimethylolpropane tris (thioglycolate), trimethylolpropane tris (β-mercaptopropionate), pentaerythritol tetrakis (thioglycolate) and pentaerythritol tetrakis (β-mercaptopropionate), and mixtures thereof.

Suitable polyacids and polyols useful as curing agents include any of those known in the art, such as those described herein for the making of polyesters.

Appropriate mixtures of crosslinking agents may also be used in the invention.

The amount of curing agent (b) in the curable film-forming composition generally ranges from 5 to 75% by weight, based on the total weight of resin solids in the curable film-forming composition. For example, the minimum amount of crosslinking agent may be at least 5% by weight, often at least 10% by weight and more often, at least 15% by weight, based on the total weight of resin solids in the curable film-forming composition. The maximum amount of crosslinking agent may be 75% by weight, more often 60% by weight, or 50% by weight, based on the total weight of resin solids in the curable film-forming composition. Ranges of crosslinking agent may include, for example, 5 to 50% by weight, 5 to 60% by weight, 10 to 50% by weight, 10 to 60% by weight, 10 to 75% by weight, 15 to 50% by weight, 15 to 60% by weight, and 15 to 75% by weight, based on the total weight of resin solids in the curable film-forming composition.

The resin component (a) may comprise epoxide functional groups and the curing agent component (b) may comprise amine functional groups. For example, the coating composition may comprise, consist essentially of, or consist of a film-forming binder comprising a resin component comprising epoxide functional groups, curing agent comprising amine functional groups, an organic solvent, and at least one of the corrosion inhibitors discussed above.

The film-forming binder may be present in the coating and/or curable film-forming coating composition in an amount of at least 5% by weight, such as at least 15% by weight, such as at least 30% by weight, such as at least 35% by weight, such as at least 40% by weight, such as at least 45% by weight, such as at least 50% by weight, based on the total weight of the coating and/or curable film-forming coating composition. The film-forming binder may be present in the coating and/or curable film-forming coating composition in an amount of no more than 75% by weight, such as no more than 65% by weight, such as no more than 55% by weight, such as no more than 50% by weight, such as no more than 40% by weight, based on the total weight of the coating and/or curable film-forming coating composition. The film-forming binder may be present in the coating and/or curable film-forming coating composition in an amount of 5% to 75% by weight, such as 5% to 65% by weight, such as 5% to 55% by weight, such as 5% to 50% by weight, such as 5% to 40% by weight, such as 15% to 75% by weight, such as 15% to 65% by weight, such as 15% to 55% by weight, such as 15% to 50% by weight, such as 15% to 40% by weight, such as 30% to 75% by weight, such as 30% to 65% by weight, such as 30% to 55% by weight, such as 30% to 50% by weight, such as 30% to 40% by weight, such as 35% to 75% by weight, such as 35% to 65% by weight, such as 35% to 55% by weight, such as 35% to 50% by weight, such as 35% to 40% by weight, such as 40% to 75% by weight, such as 40% to 65% by weight, such as 40% to 55% by weight, such as 40% to 50% by weight, such as 45% to 75% by weight, such as 45% to 65% by weight, such as 45% to 55% by weight, such as 45% to 50% by weight, such as 50% to 75% by weight, such as 50% to 65% by weight, such as 50% to 55% by weight, based on the total weight of the coating and/or curable film-forming coating composition.

### Aluminum Particles

The coating and/or curable film-forming coating composition of the present invention comprises aluminum particles. As used herein, the terms “aluminum” or “aluminum particles” when referring to metal particles refers to metal particles comprising at least 92% metallic aluminum with the rest of the particle including impurities in the form of other metals or metal oxides, such as, for example, metal particles marketed as aluminum powder or aluminum dust, and includes metal particles having up to 100% metallic aluminum. As used herein, an “aluminum alloy” refers to an alloy having aluminum as the predominant metal, such as an alloy comprising at least 50% by weight of aluminum, based on the total weight of the aluminum alloy. As used herein, “aluminum particles” may refer to either or both of aluminum particles or aluminum alloy particles.

The aluminum particles may be subjected to a surface treatment to modify the surface of the aluminum particle. The surface treated aluminum particles may comprise a pretreatment layer formed by exposing the metal particle to a pretreatment composition. As used herein, the term “pretreatment composition” refers to a composition that upon contact with the substrate reacts with and chemically alters the substrate surface and binds to it to form a protective layer. The pretreatment composition used to modify the surface of the aluminum particles may comprise any known in the art for pretreating aluminum substrates. For example, suitable pretreatment compositions include, but are not limited to, zinc phosphate pretreatment compositions, such as, for example, those described in U.S. Pat. Nos. 4,793,867 and 5,588,989, or zirconium-containing pretreatment compositions, such as, for example, those described in U.S. Pat. Nos. 7,749,368 and 8,673,091. Other non-limiting examples of a pretreatment composition include those comprising trivalent chromium, hexavalent chromium, lithium salts, permanganate, rare earth metals, such as yttrium, or lanthanides, such as cerium. Another non-limiting example of a suitable surface pretreatment solution is a solgel, such as those comprising alkoxy-silanes, alkoxy-zirconates, and/or alkoxy-titanates.

The aluminum particles may have an average particle size of at least 1 micron, such as at least 2 microns, such as at least 5 microns, such as at least 5.5 microns, such as at least 6 microns, and may be no more than 150 microns, such as no more than 30 microns, such as no more than 20 microns, such as no more than 10 microns, such as no more than 8 microns. The aluminum particles may have an average particle size of 1 to 150 microns, such as 2 to 30 microns, such as 5 to 20 microns, such as 5.5 to 10 microns, such as 6 to 8 microns. The particle size selected may be dependent upon the thickness of the desired coating. For example, thin coatings may require smaller particle sizes, while thicker coatings could tolerate larger particles. The average particle size as reported herein is the average particle size as provided by the aluminum particulate manufacturer, and may be measured by various methods known in the art.

The coating and/or the curable film-forming coating composition may comprise aluminum particles in an amount of at least 5% by weight, such as at least 10% by weight, such as at least 20% by weight, such as at least 30% by weight, such as at least 40% by weight, such as at least 50% by weight, based on the total weight of the coating or total solids weight of the composition. The coating and/or the curable film-forming coating composition may comprise aluminum particles in an amount of no more than 90% by weight, such as no more than 80% by weight, such as no more than 70% by weight, such as no more than 60% by weight, such as no more than 50% by weight, such as no more than 40% by weight, based on the total weight of the coating or total solids weight of the composition. The coating and/or the curable film-forming coating composition may comprise aluminum particles in an amount of 5% to 90% by weight, such as 5% to 80% by weight, such as 5% to 70% by weight, such as 5% to 60% by weight, such as 5% to 50% by weight, such as 5% to 40% by weight, such as 10% to 90% by weight, such as 10% to 80% by weight, such as 10% to 70% by weight, such as 10% to 60% by weight, such as 10% to 50% by weight, such as 10% to 40% by weight, such as 20% to 90% by weight, such as 20% to 80% by weight, such as 20% to 70% by weight, such as 20% to 60% by weight, such as 20% to 50% by weight, such as 20% to 40% by weight, such as 30% to 90% by weight, such as 30% to 80% by weight, such as 30% to 70% by weight, such as 30% to 60% by weight, such as 30% to 50% by weight, such as 30% to 40% by weight, such as 40% to 90% by weight, such as 40% to 80% by weight, such as 40% to 70% by weight, such as 40% to 60% by weight, such as 40% to 50% by weight, such as 50% to 90% by weight, such as 50% to 80% by weight, such as 50% to 70% by weight, such as 50% to 60% by weight, based on the total weight of the coating or total solids weight of the composition.

### Magnesium Oxide

The coating and/or curable film-forming coating composition of the present invention comprises magnesium oxide (MgO).

The magnesium oxide functions as a corrosion inhibitor in the coating. A “corrosion inhibitor” will be understood as referring to a compound that inhibits corrosion of metal. The effectiveness of the corrosion inhibitor in a cured coating in preventing corrosion of the substrate onto which the coating composition is applied and cured may be demonstrated by conventional tests used in the industry, such as, for example, salt spray corrosion testing according to ASTM B117 and/or cyclic corrosion testing according to GMW-14872, as described in the Examples section below. Whether the corrosion inhibitor improves corrosion resistance may be determined by testing the ability of the cured coating comprising the corrosion inhibitor to improve the corrosion performance as measured by one or more methods, such as through enhanced scribe appearance, reduced scribe corrosion, and/or lessening of blistering around the scribe or on the field, when compared to a similar cured coating that does not include the corrosion inhibitor.

Any MgO of any number average particle size can be used according to the present invention. The number average particle size may be determined by visually examining a micrograph of a transmission electron microscopy (“TEM”) image as described below. For example, the MgO may be micron sized, such as 0.5 to 50 microns or 1 to 15 microns, with size based on average particle size. Alternatively, or in addition, the MgO may be nano sized, such as 10 to 499 nanometers, or 10 to 100 nanometers, or 20 to 499 nanometers, or 20 to 100 nanometers, or 30 to 499 nanometers, or 30 to 100 nanometers, with size based on number average particle size. It will be appreciated that these particle sizes refer to the particle size of the MgO at the time of incorporation into the curable film-forming composition. Various coating preparation methods may result in the MgO particles agglomerating, which could increase average particle size, or shearing or other action that can reduce average particle size. MgO is commercially available from a number of sources. It will be appreciated that particles sizes in the coating composition and/or coating may also fall within these ranges.

Ultrafine MgO particles may be used in the corrosion inhibitor (2). As used herein, the term “ultrafine” refers to particles that have a B.E.T. specific surface area of at least 5 square meters per gram, such as at least 10 square meters per gram, such as 30 to 500 square meters per gram, or, in some cases, 80 to 250 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938). It will be appreciated that the B.E.T. surface area of the particles in the coating composition and/or coating may also fall within these ranges.

The curable film-forming compositions of the present invention may comprise MgO particles having a calculated equivalent spherical diameter of no more than 200 nanometers, such as no more than 100 nanometers, or, for example, 5 to 50 nanometers. As will be understood by those skilled in the art, a calculated equivalent spherical diameter can be determined from the B.E.T. specific surface area according to the following equation: Diameter (nanometers)=6000/[BET (m²/g)*.rho. (grams/cm³)]. It will be appreciated that the calculated equivalent spherical diameter of the particles in the coating composition and/or coating may also fall within these ranges.

Optionally, the MgO particles may have a number average primary particle size of no more than 100 nanometers, such as no more than 50 nanometers, or no more than 25 nanometers, as determined by visually examining a micrograph of a transmission electron microscopy (“TEM”) image, measuring the diameter of the particles in the image, and calculating the average primary particle size of the measured particles based on magnification of the TEM image. One of ordinary skill in the art will understand how to prepare such a TEM image and determine the primary particle size based on the magnification. The primary particle size of a particle refers to the smallest diameter sphere that will completely enclose the particle. As used herein, the term “primary particle size” refers to the size of an individual particle as opposed to an agglomeration of two or more individual particles. It will be appreciated that primary particles size of the particles in the coating composition and/or coating may also fall within these ranges.

Optionally, the MgO particles may have a particle size of at least 20 nm, such as at least 25 nm, such as at least 30 nm, such as at least 40 nm, such as at least 50 nm, such as at least 60 nm, such as at least 100 nm, or larger, as measured using an aqueous dispersion adjusted to a solid MgO concentration of 0.1% by weight with ion exchange water and measured by laser light scattering particle distributor, Coulter model N4 (manufactured by Coulter) at 20° C.

The shape (or morphology) of the MgO particles may vary. For example, generally spherical morphologies may be used, as well as particles that are cubic, platy, polyhedric, or acicular (elongated or fibrous). The particles may be covered completely in a polymeric gel, not covered at all in a polymeric gel, or covered partially with a polymeric gel. Covered partially with a polymeric gel means that at least some portion of the particle has a polymeric gel deposited thereon, which, for example, may be covalently bonded to the particle or merely associated with the particle.

The amount of MgO present in the coating and/or curable film-forming composition may vary. For example, the coating and/or curable film-forming composition may comprise at least 5% by weight magnesium oxide, such as at least 10% by weight, such as at least 12% by weight, such as at least 17% by weight, such as at least 25% by weight, such as at least 40% by weight, such as at least 45% by weight, such as at least 55% by weight, such as at least 65% by weight, based on the total weight of the coating and/or curable film-forming composition. The coating and/or curable film-forming composition may comprise no more than 70% by weight magnesium oxide, such as no more than 60% by weight, such as no more than 50% by weight, such as no more than 40% by weight, such as no more than 30% by weight, such as no more than 20% by weight, such as no more than 15% by weight, based on the total weight of the coating and/or curable film-forming composition. The coating and/or curable film-forming composition may comprise 5% to 70% by weight magnesium oxide, such as 5% to 60% by weight, such as 5% to 50% by weight, such as 5% to 40% by weight, such as 5% to 30% by weight, such as 5% to 20% by weight, such as 5% to 15% by weight, such as 10% to 70% by weight, such as 10% to 60% by weight, such as 10% to 50% by weight, such as 10% to 40% by weight, such as 10% to 30% by weight, such as 10% to 20% by weight, such as 10% to 15% by weight, such as 12% to 70% by weight, such as 12% to 60% by weight, such as 12% to 50% by weight, such as 12% to 40% by weight, such as 12% to 30% by weight, such as 12% to 20% by weight, such as 12% to 15% by weight, such as 17% to 70% by weight, such as 17% to 60% by weight, such as 17% to 50% by weight, such as 17% to 40% by weight, such as 17% to 30% by weight, such as 17% to 20% by weight, such as 25% to 70% by weight, such as 25% to 60% by weight, such as 25% to 50% by weight, such as 25% to 40% by weight, such as 25% to 30% by weight, such as 40% to 70% by weight, such as 40% to 60% by weight, such as 40% to 50% by weight, such as 45% to 70% by weight, such as 45% to 60% by weight, such as 45% to 50% by weight, such as 55% to 70% by weight, such as 55% to 60% by weight, such as 65% to 70% by weight, based on the total weight of the coating and/or curable film-forming composition.

The MgO may be present in the coating and/or curable film-forming composition in an amount of at least 10 parts, such as at least 20 parts, such as at least 30 parts, such as at least 40 parts, such as at least 50 parts, such as at least 60 parts, such as at least 70 parts per 100 parts film-forming binder. The MgO may be present in the coating and/or curable film-forming composition in an amount of no more than 400 parts, such as no more than 300 parts, such as no more than 200 parts, such as no more than 100 parts, such as no more than 90 parts, such as no more than 80 parts, such as no more than 70 parts, such as no more than 60 parts, such as no more than 50 parts per 100 parts film-forming binder. The MgO may be present in the coating and/or curable film-forming composition in an amount of 10 to 400 parts, such as 10 to 300 parts, such as 10 to 200 parts, such as 10 to 100 parts, such as 10 to 90 parts, such as 10 to 80 parts, such as 10 to 70 parts, such as 10 to 60 parts, such as 10 to 50 parts, such as 20 to 400 parts, such as 20 to 300 parts, such as 20 to 200 parts, such as 20 to 100 parts, such as 20 to 90 parts, such as 20 to 80 parts, such as 20 to 70 parts, such as 20 to 60 parts, such as 20 to 50 parts, such as 30 to 400 parts, such as 30 to 300 parts, such as 30 to 200 parts, such as 30 to 100 parts, such as 30 to 90 parts, such as 30 to 80 parts, such as 30 to 70 parts, such as 30 to 60 parts, such as 30 to 50 parts, such as 40 to 400 parts, such as 40 to 300 parts, such as 40 to 200 parts, such as 40 to 100 parts, such as 40 to 90 parts, such as 40 to 80 parts, such as 40 to 70 parts, such as 40 to 60 parts, such as 40 to 50 parts, such as 50 to 400 parts, such as 50 to 300 parts, such as 50 to 200 parts, such as 50 to 100 parts, such as 50 to 90 parts, such as 50 to 80 parts, such as 50 to 70 parts, such as 50 to 60 parts, such as 60 to 400 parts, such as 60 to 300 parts, such as 60 to 200 parts, such as 60 to 100 parts, such as 60 to 90 parts, such as 60 to 80 parts, such as 60 to 70 parts, such as 70 to 400 parts, such as 70 to 300 parts, such as 70 to 200 parts, such as 70 to 100 parts, such as 70 to 90 parts, such as 70 to 80 parts per 100 parts film-forming binder.

The coating and/or curable film-forming composition may comprise a pigment component that comprises the magnesium oxide, aluminum and/or iron compound, and other optional pigment components that are not corrosion inhibitors. The pigment component may comprise MgO in an amount of at least 10% by weight, such as at least 20% by weight, such as at least 30% by weight, such as at least 40% by weight, such as at least 50% by weight, such as at least 55% by weight, such as at least 60% by weight, such as at least 75% by weight, based on the total weight of the pigment component. The pigment component may comprise MgO in an amount of no more than 99% by weight, such as no more than 95% by weight, such as no more than 90% by weight, such as no more than 80% by weight, such as no more than 65% by weight, such as no more than 50% by weight, such as no more than 40% by weight, such as no more than 30% by weight, such as no more than 1% by weight, based on the total weight of the pigment component. The pigment component may comprise MgO in an amount of 10% to 99% by weight, such as 10% to 95% by weight, such as 10% to 90% by weight, such as 10% to 80% by weight, such as 10% to 65% by weight, such as 10% to 50% by weight, such as 10% to 40% by weight, such as 10% to 30% by weight, 20% to 99% by weight, such as 20% to 95% by weight, such as such as 20% to 90% by weight, such as 20% to 80% by weight, such as 20% to 65% by weight, such as 20% to 50% by weight, such as 20% to 40% by weight, such as 20% to 30% by weight, 30% to 99% by weight, such as 30% to 95% by weight, such as such as 30% to 90% by weight, such as 30% to 80% by weight, such as 30% to 65% by weight, such as 30% to 50% by weight, such as 30% to 40% by weight, 40% to 99% by weight, such as 40% to 95% by weight, such as such as 40% to 90% by weight, such as 40% to 80% by weight, such as 40% to 65% by weight, such as 40% to 50% by weight, such as 50% to 99% by weight, such as 50% to 95% by weight, such as 50% to 90% by weight, such as 50% to 80% by weight, such as 50% to 65% by weight, such as 55% to 95% by weight, such as 55% to 90% by weight, such as 55% to 80% by weight, such as 55% to 65% by weight, such as 60% to 99% by weight, such as 60% to 95% by weight, such as 60% to 90% by weight, such as 60% to 80% by weight, such as 60% to 65% by weight, such as 75% to 99% by weight, such as 75% to 95% by weight, such as 75% to 90% by weight, such as 75% to 80% by weight, based on the total weight of the pigment component.

The amount of MgO may be higher than the amount of any other corrosion inhibitor used in the coating and/or composition, and may be higher than any corrosion inhibitor that is in an adjacent coating layer.

### Aluminum and/or Iron Compound

The coating and/or curable film-forming coating composition of the present invention further comprises an aluminum and/or iron compound.

The aluminum and/or iron compound may also function as a corrosion inhibitor in the coating of the present invention.

It has been surprisingly discovered that the use of the magnesium oxide and aluminum and/or iron compound in the coating and curable film-forming coating composition of the present invention results in a coating that provides superior corrosion performance than prior corrosion resistant coating compositions.

The aluminum and/or iron compound may comprise a soluble aluminum and/or iron compound. As used herein, a “soluble” aluminum and/or iron compound is capable of releasing solubilized aluminum or iron when exposed to water. For example, the soluble aluminum and/or iron compound may result in a solubilized aluminum or iron concentration of at least 0.1 ppm, such as at least 1 ppm, such as at least 1.5 ppm, such as at least 1.9 ppm, such as at least 2 ppm, such as at least 2.2 ppm, such as at least 50 ppm, such as at least 100 ppm, such as at least 200 ppm, such as at least 500 ppm, such as at least 800 ppm, such as at least 1,000 ppm, such as at least 2,000 ppm, such as at least 3,000 ppm when 1 part of the aluminum compound or iron compound is combined with 100 parts water, stirred for 24 hours, centrifuged to remove remaining powder, and taking an aliquot of the water to be analyzed by Inductively Coupled Plasma (ICP) analysis to quantify the concentration of soluble aluminum or iron (reported in parts per million (ppm) of soluble metal).

Non-limiting examples of suitable aluminum compounds include alkali aluminate (such as sodium aluminate), aluminum hydroxide, and/or aluminum phosphate, and the aluminum and/or iron compound may comprise, consist essentially of, or consist of alkali aluminate (such as sodium aluminate), aluminum hydroxide, and/or aluminum phosphate.

Non-limiting examples of suitable iron compounds include iron phosphate, iron sulfate, and/or iron hydroxide, and the aluminum and/or iron compound may comprise, consist essentially of, or consist of iron phosphate, iron sulfate, and/or iron hydroxide.

The particle size of the aluminum and/or iron compound is not limited and any suitable number average particle size may be used according to the present invention. For example, the aluminum and/or iron compound may be micron sized, such as 0.5 to 50 microns or 1 to 15 microns, with size based on average particle size. Alternatively, or in addition, the aluminum and/or iron compound may be nano sized, such as 10 to 499 nanometers, or 10 to 100 nanometers, with size based on number average particle size. It will be appreciated that these particle sizes refer to the particle size of the aluminum and/or iron compound at the time of incorporation into the curable film-forming composition. Various coating preparation methods may result in the aluminum and/or iron compound particles agglomerating, which could increase average particle size, or shearing or other action that can reduce average particle size. The aluminum and/or iron compounds are commercially available from a number of sources.

The shape (or morphology) of the aluminum and/or iron compound particles may vary. For example, generally spherical morphologies may be used, as well as particles that are cubic, platy, polyhedric, or acicular (elongated or fibrous).

Without intending to be bound by any theory, it is believed that the aluminum and/or iron compound must be present in an amount that will leach a sufficient amount of solubilized aluminum and/or iron when exposed to water in order to provide a corrosion response, and the content of the aluminum and/or iron compound may be dependent upon the ability of the aluminum and/or iron compound to release solubilized aluminum or iron into water and may be related to the compound's solubility. For example, it is believed that more soluble compounds that release more solubilized aluminum or iron into water may be used at lesser amounts than less soluble compounds.

The aluminum and/or iron compound may be present in an amount of at least 0.05% by weight, such as at least 0.5% by weight, such as at least 1% by weight, such as at least 3% by weight, such as at least 5% by weight, such as at least 10% by weight, such as at least 20% by weight, such as at least 25% by weight, based on the total weight of the coating and/or curable film-forming composition. The aluminum and/or iron compound may be present in an amount of no more than 30% by weight, such as no more than 20% by weight, such as no more than 10% by weight, such as no more than 7% by weight, such as no more than 5% by weight, such as no more than 3% by weight, such as no more than 1% by weight, based on the total weight of the coating and/or curable film-forming composition. The aluminum and/or iron compound may be present in an amount of 0.05% to 30% by weight, such as 0.05% to 20% by weight, such as 0.05% to 10% by weight, such as 0.05% to 7% by weight, such as 0.05% to 5% by weight, such as 0.05% to 3% by weight, such as 0.05% to 1% by weight, such as 0.5% to 30% by weight, such as 0.5% to 20% by weight, such as 0.5% to 10% by weight, such as 0.5% to 7% by weight, such as 0.5% to 5% by weight, such as 0.5% to 3% by weight, such as 0.5% to 1% by weight, such as 1% to 30% by weight, such as 1% to 20% by weight, such as 1% to 10% by weight, such as 1% to 7% by weight, such as 1% to 5% by weight, such as 1% to 3% by weight, such as 3% to 30% by weight, such as 3% to 20% by weight, such as 3% to 10% by weight, such as 3% to 7% by weight, such as 3% to 5% by weight, such as 5% to 30% by weight, such as 5% to 20% by weight, such as 5% to 10% by weight, such as 5% to 7% by weight, such as 10% to 30% by weight, such as 10% to 20% by weight, such as 20% to 30% by weight, such as 25% to 30% by weight, based on the total weight of the coating and/or curable film-forming composition.

The aluminum and/or iron compound may be present in the coating and/or curable film-forming composition in an amount of at least 0.1 parts, such as at least 1 parts, such as at least 5 parts, such as at least 10 parts, such as at least 20 parts, such as at least 30 parts, such as at least 40 parts per 100 parts film-forming binder. The aluminum and/or iron compound may be present in the coating and/or curable film-forming composition in an amount of no more than 50 parts, such as no more than 40 parts, such as no more than 30 parts, such as no more than 20 parts, such as no more than 10 parts, such as no more than 5 parts, such as no more than 3 parts per 100 parts film-forming binder. The aluminum and/or iron compound may be present in the coating and/or curable film-forming composition in an amount of 0.1 to 50 parts, such as 0.1 to 40 parts, such as 0.1 to 30 parts, such as 0.1 to 20 parts, such as 0.1 to 10 parts, such as 0.1 to 5 parts, such as 0.1 to 3 parts, such as 1 to 50 parts, such as 1 to 40 parts, such as 1 to 30 parts, such as 1 to 20 parts, such as 1 to 10 parts, such as 1 to 5 parts, such as 1 to 3 parts, such as 5 to 50 parts, such as 5 to 40 parts, such as 5 to 30 parts, such as 5 to 20 parts, such as 5 to 10 parts, such as 10 to 50 parts, such as 10 to 40 parts, such as 10 to 30 parts, such as 10 to 20 parts, such as 20 to 50 parts, such as 20 to 40 parts, such as 20 to 30 parts, such as 30 to 50 parts, such as 30 to 40 parts, such as 40 to 50 parts per 100 parts film-forming binder.

The pigment component may comprise the aluminum and/or iron compound in an amount of at least 0.05% by weight, such as at least 0.5% by weight, such as at least 1% by weight, such as at least 3% by weight, such as at least 5% by weight, such as at least 10% by weight, such as at least 20% by weight, such as at least 25% by weight, based on the total weight of the pigment component. The pigment component may comprise the aluminum and/or iron compound in an amount of no more than 35% by weight, such as no more than 30% by weight, such as no more than 20% by weight, such as no more than 10% by weight, such as no more than 7% by weight, such as no more than 5% by weight, such as no more than 3% by weight, such as no more than 1% by weight, based on the total weight of the pigment component. The pigment component may comprise the aluminum and/or iron compound in an amount of 0.05% to 35% by weight, such as 0.05% to 30% by weight, such as 0.05% to 20% by weight, such as 0.05% to 10% by weight, such as 0.05% to 7% by weight, such as 0.05% to 5% by weight, such as 0.05% to 3% by weight, such as 0.05% to 1% by weight, 0.5% to 35% by weight, such as 0.5% to 30% by weight, such as 0.5% to 20% by weight, such as 0.5% to 10% by weight, such as 0.5% to 7% by weight, such as 0.5% to 5% by weight, such as 0.5% to 3% by weight, such as 0.5% to 1% by weight, 1% to 35% by weight, such as 1% to 30% by weight, such as 1% to 20% by weight, such as 1% to 10% by weight, such as 1% to 7% by weight, such as 1% to 5% by weight, such as 1% to 3% by weight, 3% to 35% by weight, such as 3% to 30% by weight, such as 3% to 20% by weight, such as 3% to 10% by weight, such as 3% to 7% by weight, such as 3% to 5% by weight, 5% to 35% by weight, such as 5% to 30% by weight, such as 5% to 20% by weight, such as 5% to 10% by weight, such as 5% to 7% by weight, 10% to 35% by weight, such as 10% to 30% by weight, such as 10% to 20% by weight, 20% to 35% by weight, such as 20% to 30% by weight, 25% to 35% by weight, such as 25% to 30% by weight, based on the total weight of the pigment component.

The magnesium oxide and aluminum and/or iron compound may be present in amounts such that the weight ratio of magnesium oxide to aluminum and/or iron compound may be at least 1:1, such as at least 2:1, such as at least 3:1, such at least 10:1, such as at least 20:1, such as at least 30:1, such as at least 45:1, such as at least 55:1, such as at least 70:1, such as at least 100:1. The magnesium oxide and aluminum and/or iron compound may be present in amounts such that the weight ratio of magnesium oxide to aluminum and/or iron compound may be no more than 240:1, such as no more than 120:1, such as no more than 100:1, such as no more than 90:1, such as no more than 75:1, such as no more than 65:1, such as no more than 60:1, such as no more than 50:1, such as no more than 40:1, such as no more than 30:1, such as no more than 20:1, such as no more than 10:1. The magnesium oxide and aluminum and/or iron compound may be present in amounts such that the weight ratio of magnesium oxide to aluminum and/or iron compound may be from 1:1 to 240:1, such as 1:1 to 120:1, such as 1:1 to 100:1, such as 1:1 to 90:1, such as 1:1 to 75:1, such as 1:1 to 65:1, such as 1:1 to 60:1, such as 1:1 to 50:1, such as 1:1 to 40:1, such as 1:1 to 30:1, such as 1:1 to 20:1, such as 1:1 to 10:1, such as 2:1 to 240:1, such as 2:1 to 120:1, such as 2:1 to 100:1, such as 2:1 to 90:1, such as 2:1 to 75:1, such as 2:1 to 65:1, such as 2:1 to 60:1, such as 2:1 to 50:1, such as 2:1 to 40:1, such as 2:1 to 30:1, such as 2:1 to 20:1, such as 2:1 to 10:1, such as 3:1 to 240:1, such as 3:1 to 120:1, such as 3:1 to 100:1, such as 3:1 to 90:1, such as 3:1 to 75:1, such as 3:1 to 65:1, such as 3:1 to 60:1, such as 3:1 to 50:1, such as 3:1 to 40:1, such as 3:1 to 30:1, such as 3:1 to 20:1, such as 3:1 to 10:1, such as 10:1 to 240:1, such as 10:1 to 120:1, such as 10:1 to 100:1, such as 10:1 to 90:1, such as 10:1 to 75:1, such as 10:1 to 65:1, such as 10:1 to 60:1, such as 10:1 to 50:1, such as 10:1 to 40:1, such as 10:1 to 30:1, such as 10:1 to 20:1, such as 20:1 to 240:1, such as 20:1 to 120:1, such as 20:1 to 100:1, such as 20:1 to 90:1, such as 20:1 to 75:1, such as 20:1 to 65:1, such as 20:1 to 60:1, such as 20:1 to 50:1, such as 20:1 to 40:1, such as 20:1 to 30:1, such as 30:1 to 240:1, such as 30:1 to 120:1, such as 30:1 to 100:1, such as 30:1 to 90:1, such as 30:1 to 75:1, such as 30:1 to 65:1, such as 30:1 to 60:1, such as 30:1 to 50:1, such as 30:1 to 40:1, such as 45:1 to 240:1, such as 45:1 to 120:1, such as 45:1 to 100:1, such as 45:1 to 90:1, such as 45:1 to 75:1, such as 45:1 to 65:1, such as 45:1 to 60:1, such as 45:1 to 50:1, such as 55:1 to 240:1, such as 55:1 to 120:1, such as 55:1 to 100:1, such as 55:1 to 90:1, such as 55:1 to 75:1, such as 55:1 to 65:1, such as 55:1 to 60:1, such as 70:1 to 240:1, such as 70:1 to 120:1, such as 70:1 to 100:1, such as 70:1 to 90:1, such as 70:1 to 75:1, such as 100:1 to 240:1, such as 100:1 to 120:1.

The coating formed on the metal substrate may have a pH of greater than 7, such as greater than 8, such as greater than 9, such as greater than 10. The coating formed on the metal substrate may have a pH of 7 to 12, such as 8 to 12, such as 9 to 12, such as 10 to 12, such as 11 to 12, such as 7 to 11, such as 8 to 11, such as 9 to 11, such as 10 to 11, such as 7 to 10, such as 8 to 10, such as 9 to 10, such as 7 to 9, such as 8 to 9.

### Further Components of the Coating Compositions

The coatings and/or coating compositions of the present invention may comprise additional optional components.

The coating and/or coating composition according to the present invention may optionally comprise one or more further components in addition to the film-forming resin component, the curing agent component, and magnesium oxide and aluminum and/or iron compound described above.

The coatings and/or curable film-forming compositions of the present invention may further comprise one or more additional corrosion inhibitors.

Amino acid(s) are also suitable additional corrosion inhibitors according to the present invention. Amino acids will be understood by those skilled in the art as compounds having both acid and amine functionality, with side chains specific to each amino acid. The amino acid may be monomeric or oligomeric, including a dimer. When an oligomeric amino acid is used, the molecular weight, as determined by GPC, of the oligomer is often less than 1000.

Particularly suitable amino acids are histidine, arginine, lysine, cysteine, cystine, tryptophan, methionine, phenylalanine and tyrosine. Mixtures may also be used. The amino acids can be either L- or D-enantiomers, which are mirror images of each other, or mixtures thereof. The L-configurations are typically found in proteins and nature and as such are widely commercially available. The term “amino acids” as used herein therefore refers to both the D- and L-configurations; it is foreseen that only the L- or only the D-configuration may be included. Amino acids can be purchased, for example, from Sigma Aldrich, Thermo Fisher Scientific, Hawkins Pharmaceutical, or Ajinomato. Often the amino acids glycine, arginine, proline, cysteine and/or methionine are specifically excluded.

The amino acid can be present in any amount that improves the corrosion resistance of the coating. For example, the amino acid may be present in an amount of 0.1 to 20 percent by weight, such as at least 0.1 percent by weight or at least 2 percent by weight and at most 20 percent by weight or at most 4 percent by weight; exemplary ranges include 0.1 to 4 percent by weight, 2 to 4 percent by weight, or 2 to 20 percent by weight, based on the total weight of resin solids in the curable film-forming composition.

An azole may also be a suitable additional corrosion inhibitor. Examples of suitable azoles include benzotriazoles such as 5-methyl benzotriazole, tolyltriazole, 2,5-dimercapto-1,3,4-thiadiazole, 2-mercaptobenzothiazole, 2-mercaptobenzimidazole, 1-phenyl-5-mercaptotetrazole, 2-amino-5-mercapto-1,3,4-thiadiazole, 2-mercapto-1-methylimidazole, 2-amino-5-ethyl-1,3,4-thiadiazole, 2-amino-5-ethylthio-1,3,4-thiadiazole, 5-phenyltetrazole, 7h-imidazo(4,5-d)pyrimidine, and 2-amino thiazole. Salts of any of the foregoing, such as sodium and/or zinc salts, are also suitable. Additional azoles include 2-hydroxybenzothiazole, benzothiazole, 1-phenyl-4-methylimidazole, and 1-(p-tolyl)-4-methlyimidazole. A suitable azole-containing product is commercially available from WPC Technologies, as HYBRICOR 204, Hybricor 204S, and Inhibicor 1000. Mixtures of azoles may also be used. Typically, the azole is present in the curable film-forming composition, if used, in amounts as low as 0.1 percent, such as 0.1 to 25 percent by weight, based on total weight of resin solids in the curable film-forming composition.

Lithium-based compounds are also another suitable additional corrosion inhibitor. Lithium-based compounds can be used, for example, in salt form, such as an organic or inorganic salt. Examples of suitable lithium salts include but are not limited to lithium carbonate, lithium phosphate, lithium sulphate, and lithium tetraborate. Other lithium compounds include but are not limited to lithium silicate including lithium orthosilicate (Li₄SiO₄), lithium metasilicate (Li₂SiO₃), lithium zirconate, and lithium-exchanged silica particles. Curable film-forming compositions of the present invention may also exclude lithium compounds, such as lithium salt and/or lithium silicate; that is the coating compositions of the present invention may be substantially free of any of the lithium compounds described above. As used in this context, substantially free means the lithium compound, if present at all, is only present in trace amounts, such as less than 0.1 weight percent of lithium based on the total solid weight of the coating composition. If used, a lithium compound can be used in amounts of 0.1 to 4.5 percent of lithium by weight, based on the total weight of resin solids in the curable film-forming composition.

The curable film-forming compositions of the present invention, comprising (1) a film-forming binder component (i.e., (a) a film-forming resin component and (b) a curing agent component), (2) magnesium oxide, (3) an aluminum and/or iron compound, and (4) aluminum particles, may be provided and stored as one-package compositions prior to use. A one-package composition will be understood as referring to a composition wherein all the coating components are maintained in the same container after manufacture, during storage, etc. A typical one-package coating can be applied to a substrate and cured by any conventional means, such as by heating, forced air, radiation cure and the like. For some coatings, such as ambient cure coatings, it is not practical to store them as a one-package, but rather they must be stored as multi-package coatings to prevent the components from curing prior to use. The term “multi-package coatings” means coatings in which various components are maintained separately until just prior to application. The present coatings can also be multi-package coatings, such as a two-package coating.

Thus, the components (a) and (b) may be provided as a one-package (1K) or multi-package, such as a two-package (2K) system. The components of the organic film-forming binder (1) are often provided in separate packages and mixed together immediately prior to the reaction. When the reaction mixture is a multi-package system, the (2) magnesium oxide, (3) an aluminum and/or iron compound, and (4) aluminum particles may be present in either one or both of the separate components (a) and (b) and/or as an additional separate component package.

The coating and/or curable film-forming composition of the present invention may additionally include optional ingredients commonly used in such compositions. For example, the composition may further comprise a hindered amine light stabilizer for UV degradation resistance. Such hindered amine light stabilizers include those disclosed in U.S. Pat. No. 5,260,135. When they are used, they are typically present in the composition in an amount of 0.1 to 2 percent by weight, based on the total weight of resin solids in the film-forming composition. Other optional additives may be included such as colorants, plasticizers, abrasion-resistant particles, film strengthening particles, flow control agents, thixotropic agents, rheology modifiers, fillers, catalysts, antioxidants, biocides, defoamers, surfactants, wetting agents, dispersing aids, adhesion promoters, UV light absorbers and stabilizers, a stabilizing agent, organic cosolvents, reactive diluents, grind vehicles, and other customary auxiliaries, or combinations thereof. The term “colorant”, as used herein is as defined in U.S. Patent Publication No. 2012/0149820, paragraphs 29 to 38, the cited portion of which is incorporated herein by reference.

An “abrasion-resistant particle” is one that, when used in a coating, will impart some level of abrasion resistance to the coating as compared with the same coating lacking the particles. Suitable abrasion-resistant particles include organic and/or inorganic particles. Examples of suitable organic particles include, but are not limited to, diamond particles, such as diamond dust particles, and particles formed from carbide materials; examples of carbide particles include, but are not limited to, titanium carbide, silicon carbide and boron carbide. Examples of suitable inorganic particles, include but are not limited to silica; alumina; alumina silicate; silica alumina; alkali aluminosilicate; borosilicate glass; nitrides including boron nitride and silicon nitride; oxides including titanium dioxide and zinc oxide; quartz; nepheline syenite; zircon such as in the form of zirconium oxide; buddeluyite; and eudialyte. Particles of any size can be used, as can mixtures of different particles and/or different sized particles.

As used herein, the terms “adhesion promoter” and “adhesion promoting component” refer to any material that, when included in the composition, enhances the adhesion of the coating composition to a metal substrate. Such an adhesion promoting component often comprises a free acid. As used herein, the term “free acid” is meant to encompass organic and/or inorganic acids that are included as a separate component of the compositions as opposed to any acids that may be used to form a polymer that may be present in the composition. The free acid may comprise tannic acid, gallic acid, phosphoric acid, phosphorous acid, citric acid, malonic acid, a derivative thereof, or a mixture thereof. Suitable derivatives include esters, amides, and/or metal complexes of such acids. Often, the free acid comprises a phosphoric acid, such as a 100 percent orthophosphoric acid, superphosphoric acid or the aqueous solutions thereof, such as a 70 to 90 percent phosphoric acid solution.

In addition to or in lieu of such free acids, other suitable adhesion promoting components are metal phosphates, organophosphates, and organophosphonates. Suitable organophosphates and organophosphonates include those disclosed in U.S. Pat. No. 6,440,580 at column 3, line 24 to column 6, line 22, U.S. Pat. No. 5,294,265 at column 1, line 53 to column 2, line 55, and U.S. Pat. No. 5,306,526 at column 2, line 15 to column 3, line 8, the cited portions of which are incorporated herein by reference. Suitable metal phosphates include, for example, zinc phosphate, iron phosphate, manganese phosphate, calcium phosphate, magnesium phosphate, cobalt phosphate, zinc-iron phosphate, zinc-manganese phosphate, zinc-calcium phosphate, including the materials described in U.S. Pat. Nos. 4,941,930, 5,238,506, and 5,653,790. As noted above, in certain situations, phosphates are excluded.

The adhesion promoting component may comprise a phosphatized epoxy resin. Such resins may comprise the reaction product of one or more epoxy-functional materials and one or more phosphorus-containing materials. Non-limiting examples of such materials, which are suitable for use in the present invention, are disclosed in U.S. Pat. No. 6,159,549 at column 3, lines 19 to 62, the cited portion of which is incorporated by reference herein.

The coating and/or curable film-forming composition of the present invention may also comprise alkoxysilane adhesion promoting agents, for example, acryloxyalkoxysilanes, such as 7-acryloxypropyltrimethoxysilane and methacrylatoalkoxysilane, such as 7-methacryloxypropyltrimethoxysilane, as well as epoxy-functional silanes, such as 7-glycidoxypropyltrimethoxysilane. Exemplary suitable alkoxysilanes are described in U.S. Pat. No. 6,774,168 at column 2, lines 23 to 65, the cited portion of which is incorporated by reference herein.

The adhesion promoting component, if used, is usually present in the coating composition in an amount ranging from 0.05 to 20 percent by weight, such as at least 0.05 percent by weight or at least 0.25 percent by weight, and at most 20 percent by weight or at most 15 percent by weight, with ranges such as 0.05 to 15 percent by weight, 0.25 to 15 percent by weight, or 0.25 to 20 percent by weight, with the percentages by weight being based on the total weight of resin solids in the composition.

The coating and/or coating compositions of the present invention may also comprise, in addition to any of the previously described corrosion inhibiting compounds, any other corrosion resisting particles including, but are not limited to, iron phosphate, zinc phosphate, calcium ion-exchanged silica, colloidal silica, synthetic amorphous silica, and molybdates, such as calcium molybdate, zinc molybdate, barium molybdate, strontium molybdate, and mixtures thereof. Suitable calcium ion-exchanged silica is commercially available from W. R. Grace & Co. as SHIELDEX AC3 and/or SHIELDEX. C303. Suitable amorphous silica is available from W. R. Grace & Co. as SYLOID. Suitable zinc hydroxyl phosphate is commercially available from Elementis Specialties, Inc. as NALZIN. 2. These particles, if used, may be present in the compositions of the present invention in an amount ranging from 5 to 40 percent by weight, such as at least 5 percent by weight or at least 10 percent by weight, and at most 40 percent by weight or at most 25 percent by weight, with ranges such as 10 to 25 percent by weight, with the percentages by weight being based on the total solids weight of the composition or the total weight of the coating.

The curable film-forming compositions of the present invention may comprise one or more solvents including water and/or organic solvents. Suitable organic solvents include glycols, glycol ether alcohols, alcohols, ketones, and aromatics, such as xylene and toluene, acetates, mineral spirits, naphthas and/or mixtures thereof. “Acetates” include the glycol ether acetates. The solvent can be a non-aqueous solvent. “Non-aqueous solvent” and like terms means that less than 50 wt % of the solvent is water. For example, less than 10 wt %, or even less than 5 wt % or 2 wt %, of the solvent can be water. It will be understood that mixtures of solvents, including water in an amount of less than 50 wt % or containing no water, can constitute a “non-aqueous solvent”. The composition may be aqueous or water-based. This means that more than 50 wt % of the solvent is water. Such compositions have less than 50 wt %, such as less than 20 wt %, less than 10 wt %, less than 5 wt % or less than 2 wt % of organic solvent(s).

### Substrates

According to the present invention, the coating composition may be applied to a substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present invention, the metal or metal alloy may comprise, for example, cold rolled steel, hot rolled steel, steel coated with zinc metal, zinc compounds, or zinc alloys, such as electrogalvanized steel, hot-dipped galvanized steel, galvanealed steel, GALVANNEAL steel, nickel-plated steel, and steel plated with zinc alloy. Steel substrates (such as cold rolled steel or any of the steel substrates listed above) coated with a weldable, zinc-rich or iron phosphide-rich organic coating are also suitable for use in the present invention. Such weldable coating compositions are disclosed in U.S. Pat. Nos. 4,157,924 and 4,186,036. The substrate may comprise aluminum, aluminum alloys, zinc-aluminum alloys such as GALFAN, GALVALUME, aluminum plated steel, and aluminum alloy plated steel substrates. Non-limiting examples of aluminum alloys include the 1XXX, 2XXX, 3XXX, 4XXX, 5XXX, 6XXX, or 7XXX series, such as 2024, 7075, 6061 as particular examples, as well as clad aluminum alloys and cast aluminum alloys, such as, for example, the A356 series. The substrate may comprise a magnesium alloy. Non-limiting examples of magnesium alloys of the AZ31B, AZ91C, AM60B, or EV31A series also may be used as the substrate. The substrate used in the present invention may also comprise other suitable non-ferrous metals such as titanium or copper, as well as alloys of these materials. The substrate may also comprise more than one metal or metal alloy in that the substrate may be a combination of two or more metal substrates assembled together such as hot-dipped galvanized steel assembled with aluminum substrates.

Suitable metal substrates for use in the present invention include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. The substrate may comprise a vehicle or a portion or part thereof. The term “vehicle” is used in its broadest sense and includes all types of aircraft, spacecraft, watercraft, and ground vehicles. For example, a vehicle can include, aircraft such as airplanes including private aircraft, and small, medium, or large commercial passenger, freight, and military aircraft; helicopters, including private, commercial, and military helicopters; drones, aerospace vehicles including, rockets and other spacecraft. A vehicle can include a ground vehicle such as, for example, trailers, cars, trucks, buses, vans, construction vehicles, golf carts, motorcycles, bicycles, trains, and railroad cars. A vehicle can also include watercraft such as, for example, ships, boats, and hovercraft. The coating composition may be utilized to coat surfaces and parts thereof. A part may include multiple surfaces. A part may include a portion of a larger part, assembly, or apparatus. A portion of a part may be coated with the coating composition of the present invention or the entire part may be coated.

The metal substrate may be in the shape of a cylinder, such as a pipe, including, for example, a cast iron pipe. The metal substrate also may be in the form of, for example, a sheet of metal or a fabricated part.

The substrate may also comprise conductive or non-conductive substrates at least partially coated with a conductive coating. The conductive coating may comprise a conductive agent such as, for example, graphene, conductive carbon black, conductive polymers, or conductive additives.

### Methods of Coating and Coatings

The present invention is also directed to methods for coating a substrate, such as any one of the substrates mentioned above.

The coating compositions of the present invention may be applied to a substrate by any suitable coating application techniques such as, for example, flow, dip, spray and roll coating applications.

The present invention is further directed to a coating formed by at least partially curing the coating applied from the coating composition described herein. The coating comprises, consists essentially of, or consists of a film-forming binder; magnesium oxide; and an aluminum compound and/or iron compound.

As discussed above, the present invention is further directed to a substrate that is coated, at least in part, with the coating composition described herein in an at least partially cured state.

The coating compositions of the present invention may be utilized in an layer that is part of a multi-layer coating composite comprising a substrate with various coating layers. The coating layers may include a pretreatment layer, such as a phosphate layer (e.g., zinc phosphate layer), a coating layer which results from the coating composition of the present invention. The multi-layer coating composite may comprise the coating layer of the present invention as a primer and/or a top coat layer(s) (e.g., base coat, clear coat layer, pigmented monocoat, and color-plus-clear composite compositions), or the multi-layer coating composite may optionally comprise primer and/or top coat layer(s) in addition to the coating layer derived from the coating composition of the present invention. Such primer and/or top coat layer(s) in addition to the coating layer derived from the coating composition of the present invention may optionally comprise corrosion inhibitors other than magnesium oxide and the aluminum and/or iron compound, or may optionally comprise magnesium oxide and/or the aluminum and/or iron compound as well as other optional corrosion inhibitors. It is understood that suitable topcoat layers include any of those known in the art, and each independently may be waterborne, solventborne, in solid particulate form (i.e., a powder coating composition), or in the form of a powder slurry. The top coat typically includes a film-forming polymer, crosslinking material and, if a colored base coat or monocoat, one or more pigments. According to the present invention, the primer layer may be disposed between the coating layer and the base coat layer. According to the present invention, one or more of the topcoat layers may be applied onto a substantially uncured underlying layer. For example, a clear coat layer may be applied onto at least a portion of a substantially uncured basecoat layer (wet-on-wet), and both layers may be simultaneously cured in a downstream process.

Moreover, the top coat layers may be applied directly onto the coating layer. In other words, the substrate lacks a primer layer. For example, a basecoat layer may be applied directly onto at least a portion of the coating layer.

It will also be understood that the top coat layers may be applied onto an underlying layer despite the fact that the underlying layer has not been fully cured. For example, a clearcoat layer may be applied onto a basecoat layer even though the basecoat layer has not been subjected to a curing step. Both layers may then be cured during a subsequent curing step thereby eliminating the need to cure the basecoat layer and the clearcoat layer separately.

According to the present invention, additional ingredients such as colorants and fillers may be present in the various coating compositions from which the top coat layers result. Any suitable colorants and fillers may be used. For example, the colorant may be added to the coating in any suitable form, such as discrete particles, dispersions, solutions and/or flakes. A single colorant or a mixture of two or more colorants can be used in the coatings of the present invention. It should be noted that, in general, the colorant can be present in a layer of the multi-layer composite in any amount sufficient to impart the desired property, visual and/or color effect.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant may be organic or inorganic and may be agglomerated or non-agglomerated. Colorants may be incorporated into the coatings by grinding or simple mixing. Colorants may be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPP red BO”), titanium dioxide, carbon black, zinc oxide, antimony oxide, etc. and organic or inorganic UV opacifying pigments such as iron oxide, transparent red or yellow iron oxide, phthalocyanine blue and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

The colorant may be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions may include colorants such as pigments or dyes having a particle size of less than 150 nm, such as less than 70 nm, or less than 30 nm. Nanoparticles may be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions may also be produced by crystallization, precipitation, gas phase condensation, and chemical attrition (i.e., partial dissolution). In order to minimize re-agglomeration of nanoparticles within the coating, a dispersion of resin-coated nanoparticles may be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,031 filed Jun. 24, 2004, which is incorporated herein by reference, and U.S. Provisional Application No. 60/482,167 filed Jun. 24, 2003, which is also incorporated herein by reference.

According to the present invention, special effect compositions that may be used in one or more layers of the multi-layer coating composite include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions may provide other perceptible properties, such as reflectivity, opacity or texture. For example, special effect compositions may produce a color shift, such that the color of the coating changes when the coating is viewed at different angles. Example color effect compositions are identified in U.S. Pat. No. 6,894,086, incorporated herein by reference. Additional color effect compositions may include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

According to the present invention, a photosensitive composition and/or photochromic composition, which reversibly alters its color when exposed to one or more light sources, can be used in a number of layers in the multi-layer composite. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. For example, the photochromic and/or photosensitive composition may be colorless in a non-excited state and exhibit a color in an excited state. Full color-change may appear within milliseconds to several minutes, such as from 20 seconds to 60 seconds. Example photochromic and/or photosensitive compositions include photochromic dyes.

According to the present invention, the photosensitive composition and/or photochromic composition may be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

The coating composition of the present invention may be applied directly to the metal substrate when there is no intermediate coating between the substrate and the curable film-forming composition. By this is meant that the substrate may be bare, as described below, or may be treated with one or more cleaning, deoxidizing, and/or pretreatment compositions as described below, or the substrate may be anodized. Alternatively, the substrate may be coated with one or more different coating compositions prior to application of the coating composition of the present invention. The additional coating layers may comprise solgels, adhesion promoters, primers, wash primers, basecoats, or topcoats, and may be applied by any method known in the art, such as, for example, dip, roll, spray, brush, or electrodeposition.

As noted above, the substrates to be used may be bare metal substrates. By “bare” is meant a virgin metal substrate that has not been treated with any pretreatment compositions such as conventional phosphating baths, heavy metal rinses, etc. Additionally, bare metal substrates being used in the present invention may be a cut edge of a substrate that is otherwise treated and/or coated over the rest of its surface. Alternatively, the substrates may undergo one or more treatment steps known in the art prior to the application of the curable film-forming composition.

The substrate may optionally be subjected to other treatments prior to coating. For example, the substrate may be cleaned, cleaned and deoxidized, anodized, acid pickled, plasma treated, laser treated, or ion vapor deposition (IVD) treated. These optional treatments may be used on their own or in combination with a pretreatment solution. The substrate may be new (i.e., newly constructed or fabricated) or it may be refurbished, such as, for example, in the case of refinishing or repairing a component of an automobile or aircraft.

The substrate may optionally be cleaned using conventional cleaning procedures and materials. These would include mild or strong alkaline cleaners such as are commercially available and conventionally used in metal pretreatment processes. Examples of alkaline cleaners include Chemkleen 163 and Chemkleen 177, both of which are available from PPG Industries, Pretreatment and Specialty Products, and any of the DFM Series, RECC 1001, and 88X1002 cleaners commercially available from PRC-DeSoto International, Sylmar, CA), and Turco 4215-NCLT and Ridolene (commercially available from Henkel Technologies, Madison Heights, Ml). Such cleaners are often preceded or followed by a water rinse, such as with tap water, distilled water, or combinations thereof. The metal surface may also be rinsed with an aqueous acidic solution after or in place of cleaning with the alkaline cleaner. Examples of rinse solutions include mild or strong acidic cleaners such as the dilute nitric acid solutions commercially available and conventionally used in metal pretreatment processes.

According to the present invention, at least a portion of a cleaned aluminum substrate surface may be deoxidized, mechanically or chemically. As used herein, the term “deoxidize” means removal of the oxide layer found on the surface of the substrate in order to promote uniform deposition of the pretreatment composition (described below), as well as to promote the adhesion of the pretreatment composition coating and/or curable film-forming composition of the present invention to the substrate surface. Suitable deoxidizers will be familiar to those skilled in the art. A typical mechanical deoxidizer may be uniform roughening of the substrate surface, such as by using a scouring or cleaning pad. Typical chemical deoxidizers include, for example, acid-based deoxidizers such as phosphoric acid, nitric acid, fluoroboric acid, sulfuric acid, chromic acid, hydrofluoric acid, and ammonium bifluoride, or Amchem 7/17 deoxidizers (available from Henkel Technologies, Madison Heights, MI), OAKITE DEOXIDIZER LNC (commercially available from Chemetall), TURCO DEOXIDIZER 6 (commercially available from Henkel), or combinations thereof. Often, the chemical deoxidizer comprises a carrier, often an aqueous medium, so that the deoxidizer may be in the form of a solution or dispersion in the carrier, in which case the solution or dispersion may be brought into contact with the substrate by any of a variety of known techniques, such as dipping or immersion, spraying, intermittent spraying, dipping followed by spraying, spraying followed by dipping, brushing, or roll-coating.

The metal substrate may optionally be pickled by treatment with solutions comprising nitric acid and/or sulfuric acid.

The metal substrate may optionally be pretreated with any suitable solution known in the art, such as a metal phosphate solution, an aqueous solution containing at least one Group IIIB or IVB metal, an organophosphate solution, an organophosphonate solution, and combinations thereof. Other non-limiting examples of a pretreatment solution include those comprising trivalent chromium, hexavalent chromium, lithium salts, permanganate, rare earth metals, such as yttrium, or lanthanides, such as cerium. Another non-limiting example of a suitable surface pretreatment solution is a solgel, such as those comprising alkoxy-silanes, alkoxy-zirconates, and/or alkoxy-titanates.

The pretreatment solutions may be essentially free of environmentally detrimental heavy metals such as chromium and nickel.

Suitable phosphate conversion coating compositions may be any of those known in the art that are free of heavy metals. Examples include zinc phosphate, which is used most often, iron phosphate, manganese phosphate, calcium phosphate, magnesium phosphate, cobalt phosphate, zinc-iron phosphate, zinc-manganese phosphate, zinc-calcium phosphate, and layers of other types, which may contain one or more multivalent cations. Phosphating compositions are known to those skilled in the art and are described in U.S. Pat. Nos. 4,941,930, 5,238,506, and 5,653,790.

Non-limiting examples of compositions to be used in the pretreatment step include non-conductive organophosphate and organophosphonate pretreatment compositions such as those disclosed in U.S. Pat. Nos. 5,294,265 and 5,306,526. Such organophosphate or organophosphonate pretreatments are available commercially from PPG Industries, Inc. under the name NUPAL.

The IIIB or IVB transition metals and rare earth metals referred to herein are those elements included in such groups in the CAS Periodic Table of the Elements as is shown, for example, in the Handbook of Chemistry and Physics, 63rd Edition (1983).

Typical group IIIB and IVB transition metal compounds and rare earth metal compounds are compounds of zirconium, titanium, hafnium, yttrium and cerium and mixtures thereof. Typical zirconium compounds may be selected from hexafluorozirconic acid, alkali metal and ammonium salts thereof, ammonium zirconium carbonate, zirconyl nitrate, zirconium carboxylates and zirconium hydroxy carboxylates such as hydrofluorozirconic acid, zirconium acetate, zirconium oxalate, ammonium zirconium glycolate, ammonium zirconium lactate, ammonium zirconium citrate, and mixtures thereof. Hexafluorozirconic acid is used most often. An example of a titanium compound is fluorotitanic acid and its salts. An example of a hafnium compound is hafnium nitrate. An example of a yttrium compound is yttrium nitrate. An example of a cerium compound is cerous nitrate. Non-limiting examples of a zirconium containing pretreatment solution include, for example, those described in U.S. Pat. Nos. 7,749,368 and 8,673,091.

In the aerospace industry, anodized surface treatments as well as chromium based conversion coatings/pretreatments are often used on aluminum alloy substrates. Examples of anodized surface treatments would be chromic acid anodizing, phosphoric acid anodizing, boric acid-sulfuric acid anodizing, tartaric acid anodizing, sulfuric acid anodizing. Chromium based conversion coatings would include hexavalent chromium types, such as BONDERITE M-CR1200 from Henkel, and trivalent chromium types, such as BONDERITE M-CR T5900 from Henkel.

The coating composition of the present invention may be applied to the substrate using conventional techniques. The use of a spray-applied or electrodeposited primer or primer-surfacer under the coating composition of the present invention may be unnecessary when using the composition of the present invention.

The coating compositions of the present invention may be used as corrosion resistant primers. As indicated, the present invention may be directed to metal substrate primer coating compositions, such as “etch primers.” As used herein, the term “primer coating composition” refers to coating compositions from which an undercoating may be deposited onto a substrate. In some industries or on certain substrates, the primer is applied to prepare the surface for application of a protective or decorative coating system. In other industries or substrates, another coating layer is not applied on top of the primer. For example, substrate surfaces that have limited or no external exposure might have a primer with no other layer on top. As used herein, the term “etch primer” refers to primer coating compositions that include an adhesion promoting component, such as a free acid as described in more detail above.

Suitable top coats (base coats, clear coats, pigmented monocoats, and color-plus-clear composite compositions) include any of those known in the art, and each may be waterborne, solventborne or powdered. The top coat typically includes a film-forming resin, crosslinking material and pigment (in a colored base coat or monocoat). Non-limiting examples of suitable base coat compositions include waterborne base coats such as are disclosed in U.S. Pat. Nos. 4,403,003; 4,147,679; and 5,071,904. Suitable clear coat compositions include those disclosed in U.S. Pat. Nos. 4,650,718; 5,814,410; 5,891,981; and WO 98/14379.

In this multilayer coated metal substrate of the present invention, the metal substrate may be any of those disclosed above. Likewise, each of the first and second curable film-forming compositions may independently comprise any of the curable, organic film-forming compositions disclosed above. Moreover, for example, in this multilayer coated metal substrate, the curable film-forming composition may be a primer coating applied to the substrate and the second coating layer, applied on top of the first curable film-forming composition, may be a topcoat composition. The first curable film-forming composition may be a primer coating and the second coating layer may be a second primer, such as a primer surfacer. The first curable film-forming composition may be an electrodepositable coating layer and the second coating layer may be a primer or a topcoat.

The coating compositions of the present invention may be applied to a substrate by known application techniques, such as dipping or immersion, spraying, intermittent spraying, dipping followed by spraying, spraying followed by dipping, brushing, or by roll-coating. Usual spray techniques and equipment for air spraying and electrostatic spraying, either manual or automatic methods, can be used.

After application of the composition to the substrate, a film is formed on the surface of the substrate by driving solvent, i.e., organic solvent and/or water, out of the film by heating or by an air-drying period. Suitable drying conditions will depend on the particular composition and/or application, but in some instances a drying time of from about 1 to 5 minutes at a temperature of about 70 to 250° F. (27 to 121° C.) will be sufficient. More than one coating layer of the present composition may be applied if desired. Usually between coats, the previously applied coat is flashed; that is, exposed to ambient conditions for the desired amount of time. The dry film thickness of the coating is usually greater than 5 microns, such as at least 10 microns, such as at least 20 microns, such as at least 25 microns, such as at least 40 microns or more. The dry film thickness of the coating may be from 0.4 to 3 mils (10 to 75 microns), such as 1 to 2.0 mils (25 to 50 microns). The coating composition may then be heated. In the curing operation, solvents are driven off and crosslinkable components of the composition are crosslinked. The heating and curing operation is sometimes carried out at a temperature in the range of from 70 to 250° F. (27 to 121° C.) but, if needed, lower or higher temperatures may be used. As noted previously, the coatings of the present invention may also cure without the addition of heat or a drying step. Additionally, the first coating composition may be applied and then a second applied thereto “wet-on-wet”. Alternatively, the first coating composition can be cured before application of one or more additional coating layers.

The present invention is further directed to a coating formed by at least partially curing the coating composition described herein. The coating may have a dry film thickness of at least 10 microns, such as at least 20 microns, such as at least 25 microns, such as at least 40 microns or more. The dry film thickness of the coating may be from 0.4 to 3 mils (10 to 75 microns), such as 1 to 2.0 mils (25 to 50 microns).

The present invention is further directed to a substrate that is coated, at least in part, with the coating composition described herein. The coating may be in an at least partially or fully cured state. The coating may have a dry film thickness of at least 10 microns, such as at least 20 microns, such as at least 25 microns, such as at least 40 microns or more. The dry film thickness of the coating may be from 0.4 to 3 mils (10 to 75 microns), such as 1 to 2.0 mils (25 to 50 microns).

Coated metal substrates of the present invention may demonstrate excellent corrosion resistance as determined by salt spray corrosion resistance testing.

For purposes of this detailed description, it is to be understood that the invention may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “an” aluminum compound, “an” iron compound, “a” film-forming resin, “a” curing agent, a combination (i.e., a plurality) of these components may be used. In addition, in this application, the use of “or” means “and/or” unless specifically stated otherwise, even though “and/or” may be explicitly used in certain instances.

Whereas specific aspects of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

Illustrating the invention are the following examples, which, however, are not to be considered as limiting the invention to their details. Unless otherwise indicated, all parts and percentages in the following examples, as well as throughout the specification, are by weight.

### EXAMPLES

The following table provides a description of materials used in the preparation of the examples:

| Component | Description | Supplier |
|---|---|---|
| Ancamide ® 1110 | Dimethylaminomethylphenol | Evonik |
| | curing agent | |
| Ti-Pure ® R-706-11 | Titanium Dioxide | DuPont |
| Epon ® 863 | Bisphenol F/epichlorohydrin | Hexion |
| | resin | |
| Epon ® 1001-A-80 | Epoxy resin | Hexion |
| Silquest ® A187 | Epoxy-silane | Momentive |
| Nano Magnesium Oxide | MgO: 20 nm ave. particle | Nano Structured and |
| | size, 50 m²/g surface area | Amorphous Materials |
| Maglite ® Y | MgO: 10 micron ave. particle | Hallstar |
| | size, 55 m²/g surface area | |
| Magchem ® 10-325 | MgO: 10 micron ave. particle | Martin Marietta Magnesia |
| | size, 3 m²/g surface area | Specialties |
| Martinal Ol-104 Leo | Aluminum hydroxide | J. M. Huber Corportation |
| Sodium aluminate | Sodium dioxoalumanuide | Millipore Sigma |
| Hydroxy(oxo)iron | Ferric (III) Hydroxide | Alfa Aesar |
| Iron (III) sulfate hydrate | Ferric (III) Sulfate | Sigma Aldrich |
| Iron (III) phosphate hydrate | Ferric (III) Phosphate | Alfa Aesar |
| Milling media | Part #74582 minimum 85% | Coors Tek |
| | Al₂O₃ (16 to 20 mesh) | |
| RHEOBYK-7410 ET | Dispersant | BYK |
| Dynasylan ® SILBOND ® | Ethyl Silicate | Silbond |
| Condensed | | |
| SUSPENO 201-NBA | Rheological additive | Poly-Resyn, Inc. |
| BENTONE SD-2 | Organic derivative of a | ELEMENTIS |
| | bentonite clay | |
| Untreated Al | MIL-DTL-24779A (95% | Valimet, Inc. |
| | aluminum, 5% zinc, 0.015% | |
| | indium) aluminum alloy | |
| | atomized to D₅₀ 7 μm | |
| | spherical powder | |
| TCP Treated Al | Aluminum powder treated | Av-DEC ® |
| | with a trivalent-chromium | |
| | solution (TCP) by Av-DEC ® | |
| | (MPN: ARP-02) | |
| Flake Aluminum | Silver dollar, non-leafing | Eckart |
| | aluminum pigment | |
| STAPA SDF 6-1501 | Aluminum powder | ECKART |
| EFKA ® PL 5651 | Plasticizer | BASF |
| JEFFAMINE ® D-2000 | Di-functional polyetheramine | Huntsman |
| Cardolite ® NC-556B80 | Phenalkamine curing agent | Cardolite |
| Bonderite ® C-AK 6849 Aero | Alkaline Immersion Cleaner | Henkel |
| Bonderite ® C-IC Smutgo NC | Ferric Sulfate and Nitrate | Henkel |
| Aero | Acid Deoxidizer | |
| SurTec 650 | Trivalent Chrome | SurTec |
| 2024 T3 Bare Aluminum | Aluminum Substrate | Kaiser |
| C700 CRS | Chemfos ® 700 CRS | ACT |

### Examples 1-14: MgO+Aluminum Metal+Aluminum or Iron Compound Coatings in Salt Fog Testing

TABLE 1
Primer Formulations with Untreated Spherical Aluminum
for Metal Rich with Aluminum or Iron Salts

| Material | Comp Ex 1 | Ex 2 | Ex 3 | Ex 4 | Ex 5 | Ex 6 |
|---|---|---|---|---|---|---|
| Component A | g | g | g | g | g | g |
| n-Butyl acetate | 1.13 | 1.13 | 1.13 | 1.13 | 1.13 | 1.13 |
| Epon 863 | 34.09 | 34.09 | 34.09 | 34.09 | 34.09 | 34.09 |
| Epon 1001-A-80 | 38.01 | 38.01 | 38.01 | 38.01 | 38.01 | 38.01 |
| Silbond Condensed | 4.92 | 4.92 | 4.92 | 4.92 | 4.92 | 4.92 |
| Methyl Acetate | 80.80 | 80.80 | 80.80 | 80.80 | 80.80 | 80.80 |
| Suspeno 201-NBA | 3.11 | 3.11 | 3.11 | 3.11 | 3.11 | 3.11 |
| R-706 (TiO₂) | 7.70 | 7.70 | 7.70 | 7.70 | 7.70 | 7.70 |
| Bentone SD-2 | 3.72 | 3.72 | 3.72 | 3.72 | 3.72 | 3.72 |
| Magchem 10-325 | 15.00 | 15.00 | 15.00 | 15.00 | 15.00 | 15.00 |
| nano-MgO | 15.00 | 15.00 | 15.00 | 15.00 | 15.00 | 15.00 |
| Maglite Y | 30.00 | 30.00 | 30.00 | 30.00 | 30.00 | 30.00 |
| Untreated Al | 152.74 | 152.74 | 152.74 | 152.74 | 152.74 | 152.74 |
| TCP Treated Al | 0 | 0 | 0 | 0 | 0 | 0 |
| Stapa SDF 6-1501 | 0 | 0 | 0 | 0 | 0 | 0 |
| Aluminum Hydroxide | 0 | 20.00 | 0 | 0 | 0 | 0 |
| Sodium Aluminate | 0 | 0 | 1.00 | 0 | 0 | 0 |
| Ferric (III) Hydroxide | 0 | 0 | 0 | 10.00 | 0 | 0 |
| Ferric (III) Sulfate | 0 | 0 | 0 | 0 | 3.00 | 0 |
| Ferric (III) Phosphate | 0 | 0 | 0 | 0 | 0 | 6.00 |
| Silquest A-187 | 3.26 | 3.26 | 3.26 | 3.26 | 3.26 | 3.26 |
| EFKA PL 5651 | 3.47 | 3.47 | 3.47 | 3.47 | 3.47 | 3.47 |
| BYK-7410 | 1.00 | 1.00 | 1.00 | 1.00 | 1.00 | 1.00 |
| Total | 393.95 | 413.95 | 394.95 | 403.95 | 396.95 | 399.95 |
| Component B | g | g | g | g | g | g |
| T-Butyl Acetate | 35.36 | 35.36 | 35.36 | 35.36 | 35.36 | 35.36 |
| Butanol | 8.45 | 8.45 | 8.45 | 8.45 | 8.45 | 8.45 |
| Jeffamine D2000 | 3.68 | 3.68 | 3.68 | 3.68 | 3.68 | 3.68 |
| Cardolite NC-556B80 | 34.85 | 34.85 | 34.85 | 34.85 | 34.85 | 34.85 |
| Ancamine 1110 | 1.56 | 1.56 | 1.56 | 1.56 | 1.56 | 1.56 |
| Total | 83.90 | 83.90 | 83.90 | 83.90 | 83.90 | 83.90 |
| Total Blended Weight | 477.85 | 497.85 | 478.85 | 487.85 | 480.85 | 483.85 |

TABLE 1
Primer Formulations with TCP treated Spherical Aluminum
for Metal Rich with Aluminum or Iron Salts

| Material | Comp Ex 7 | Ex 8 | Ex 9 |
|---|---|---|---|
| Component A | g | g | g |
| n-Butyl acetate | 1.13 | 1.13 | 1.13 |
| Epon 863 | 34.09 | 34.09 | 34.09 |
| Epon 1001-A-80 | 38.01 | 38.01 | 38.01 |
| Silbond Condensed | 4.92 | 4.92 | 4.92 |
| Methyl Acetate | 80.80 | 80.80 | 80.80 |
| Suspeno 201-NBA | 3.11 | 3.11 | 3.11 |
| R-706 (TiO₂) | 7.70 | 7.70 | 7.70 |
| Bentone SD-2 | 3.72 | 3.72 | 3.72 |
| Magchem 10-325 | 15.00 | 15.00 | 15.00 |
| nano-MgO | 15.00 | 15.00 | 15.00 |
| Maglite Y | 30.00 | 30.00 | 30.00 |
| Untreated Al | 0 | 0 | 0 |
| TCP Treated Al | 152.74 | 152.74 | 152.74 |
| Stapa SDF 6-1501 | 0 | 0 | 0 |
| Aluminum Hydroxide | 0 | 20.00 | 0 |
| Sodium Aluminate | 0 | 0 | 1.00 |
| Ferric (III) Hydroxide | 0 | 0 | 0 |
| Ferric (III) Sulfate | 0 | 0 | 0 |
| Ferric (III) Phosphate | 0 | 0 | 0 |
| Silquest A-187 | 3.26 | 3.26 | 3.26 |
| EFKA PL 5651 | 3.47 | 3.47 | 3.47 |
| BYK-7410 | 1.00 | 1.00 | 1.00 |
| Total | 393.95 | 413.95 | 394.95 |
| Component B | g | g | g |
| T-Butyl Acetate | 35.36 | 35.36 | 35.36 |
| Butanol | 8.45 | 8.45 | 8.45 |
| Jeffamine D2000 | 3.68 | 3.68 | 3.68 |
| Cardolite NC-556B80 | 34.85 | 34.85 | 34.85 |
| Ancamine 1110 | 1.56 | 1.56 | 1.56 |
| Total | 83.90 | 83.90 | 83.90 |
| Total Blended Weight | 477.85 | 497.85 | 478.85 |

TABLE 2
Primer Formulations with Flake Aluminum for
Metal Rich with Aluminum or Iron Salts

| | Comp | | | | |
|---|---|---|---|---|---|
| Material | Ex 10 | Ex 11 | Ex 12 | Ex 13 | Ex 14 |
| Component A | g | g | g | g | g |
| n-Butyl acetate | 1.13 | 1.13 | 1.13 | 1.13 | 1.13 |
| Epon 863 | 34.09 | 34.09 | 34.09 | 34.09 | 34.09 |
| Epon 1001-A-80 | 38.01 | 38.01 | 38.01 | 38.01 | 38.01 |
| Silbond Condensed | 4.92 | 4.92 | 4.92 | 4.92 | 4.92 |
| Methyl Acetate | 80.80 | 80.80 | 80.80 | 80.80 | 80.80 |
| Suspeno 201-NBA | 3.11 | 3.11 | 3.11 | 3.11 | 3.11 |
| R-706 (TiO₂) | 7.70 | 7.70 | 7.70 | 7.70 | 7.70 |
| Bentone SD-2 | 3.72 | 3.72 | 3.72 | 3.72 | 3.72 |
| Magchem 10-325 | 15.00 | 15.00 | 15.00 | 15.00 | 15.00 |
| nano-MgO | 15.00 | 15.00 | 15.00 | 15.00 | 15.00 |
| Maglite Y | 30.00 | 30.00 | 30.00 | 30.00 | 30.00 |
| Untreated Al | 0 | 0 | 0 | 0 | 0 |
| Stapa SDF 6-1501 | 50.00 | 50.00 | 50.00 | 50.00 | 50.00 |
| Aluminum Hydroxide | 0 | 20.00 | 0 | 0 | 0 |
| Sodium Aluminate | 0 | 0 | 1.00 | 0 | 0 |
| Ferric (III) Hydroxide | 0 | 0 | 0 | 10.00 | 0 |
| Ferric (III) Sulfate | 0 | 0 | 0 | 0 | 0 |
| Ferric (III) Phosphate | 0 | 0 | 0 | 0 | 6.00 |
| Silquest A-187 | 3.26 | 3.26 | 3.26 | 3.26 | 3.26 |
| EFKA PL 5651 | 3.47 | 3.47 | 3.47 | 3.47 | 3.47 |
| BYK-7410 | 1.00 | 1.00 | 1.00 | 1.00 | 1.00 |
| Total | 291.22 | 311.22 | 292.22 | 301.22 | 297.22 |
| Component B | g | g | g | g | g |
| T-Butyl Acetate | 35.36 | 35.36 | 35.36 | 35.36 | 35.36 |
| Butanol | 8.45 | 8.45 | 8.45 | 8.45 | 8.45 |
| Jeffamine D2000 | 3.68 | 3.68 | 3.68 | 3.68 | 3.68 |
| Cardolite NC-556B80 | 34.85 | 34.85 | 34.85 | 34.85 | 34.85 |
| Ancamine 1110 | 1.56 | 1.56 | 1.56 | 1.56 | 1.56 |
| Total | 83.90 | 83.90 | 83.90 | 83.90 | 83.90 |
| Total Blended Weight | 375.11 | 395.11 | 376.11 | 385.11 | 381.11 |

For the coating compositions in Table 1 and Table 2, components in A from n-butyl acetate to ferric (III) phosphate were transferred to a glass jar in sequential order along with milling media at approximately half the weight of the component materials. The jars were sealed with lids and then placed on a Lau Dispersing Unit with a dispersion time of 2 hours. After the pigment dispersion process was completed, Silquest A-187, EFKA PL 5651 and BYK-7410 were added to the Component A mixture and thoroughly mixed. Prior to coating application, components in B were pre-blended until homogenous. The dispersed material in Compound A was combined with Compound B and blended.

The coatings of Examples 1-11 were spray applied with an HVLP spray gun onto 2024T3 bare aluminum alloy substrate panels which were pretreated to meet military specification MIL-DTL-5541F, Type II class 1A by the process described below.

Prior to coating application, the 2024T3 bare aluminum panels were first cleaned using a methyl ethyl ketone (MEK) wipe. Panels were then processed as outlined in the table below.

TABLE 3
Trivalent Chrome Pretreatment Process
MIL-DTL-5541F, Type II class 1A: Trivalent Chrome Pretreatment Process

| | Process | | | | | |
|---|---|---|---|---|---|---|
| Step | Description | Application | Solution | Time | | Temp |
| 1 | Alkaline | Immersion | 20% (vol) Bonderite C- | 5 | minutes | 60-70° C. |
| | Clean | | AK 6849 Aero in DI | | | |
| | | | Water | | | |
| 2 | Rinse | Immersion | Tap Water | 2.5 | minutes | 40-50° C. |
| 3 | Rinse | Immersion | Tap Water | 2.5 | minutes | 40-50° C. |
| 4 | Deoxidizer | Immersion | 20% (vol) Bonderite ® C- | 1 | minute | Ambient |
| | | | IC Smutgo NC Aero in DI | | | |
| | | | Water | | | |
| 5 | Rinse | Immersion | Tap Water | 1 | minute | 40-50° C. |
| 6 | Rinse | Immersion | Tap Water | 1 | minute | 40-50° C. |
| 7 | Trivalent | Immersion | 20% Sur-Tec 650 (vol) in | 4 | minutes | Ambient |
| | Chrome | | DI Water | | | |
| 8 | Rinse | Immersion | Tap Water | 1 | minute | 40-50° C. |
| 9 | Rinse | Immersion | Tap Water | 1 | minute | 40-50° C. |
| 10 | Rinse | Spray | DI Water | 0.5 | minutes | Ambient |

The coatings of Examples 1-6 and 10-14 were spray applied with an HVLP spray gun onto cold rolled steel substrate panels which were pretreated with Chemfos® 700. The pretreated panels were purchased from ACT Test Panel Technologies, item #28630, C700, no seal with deionized water rinse. The dry film thickness of the coatings Examples ranged between 1.30 to 2.11 mils.

The aluminum test panels coated with coating Examples 1-11 were allowed to age under ambient conditions for a minimum of 7 days, after which the panels were inscribed with a 0.030″ wide and 4″ long by 4″ long “X” that was engraved into the metal panel surface to a depth between 150 and 300 microns below the surface of the metal. A Gravograph IS 400 engraver with a 0.030″ quarter round carbide cutter was used to inscribe the coated aluminum test panels.

The cold rolled steel test panels with coating Examples 1-6 and 10-14 were allowed to age under ambient conditions for a minimum of 7 days, after which two intersecting lines of 4″ in length were scribed diagonally across the coated surface of each panel, exposing the bare substrate. A Fowler carbide tipped handheld scribing tool, model number 52-500-050-0, was used to inscribe the coated steel panels.

Scribed test panels of each coating example were then placed into either a 5% sodium chloride neutral salt spray cabinet according to ASTM B117 (with the exception that pH & salt concentration was checked weekly as opposed to daily) or a cyclical corrosion cabinet according to GMW 14872.

Aluminum panels were rated based on the percentage of scribe corrosion compared to the total scribe, the extent of scribe creep in millimeters, and a count of field blistering. In all cases over aluminum, a lower rating number is better The corrosion results for aluminum panels after exposure are tabulated in Tables 6 and 7.

Steel panels were rated based on the scale shown in Table 5, where a higher rating is better, as well as counting field blistering, where a lower rating is better. The corrosion results for steel panels after exposure are tabulated in Tables 8 and 9.

TABLE 4
Rating Scale for C700, Cold Rolled Steel panels

| Scribe Appearance | | Scribe Corrosion | |
|---|---|---|---|
| 10 | Bright and Clean | 10 | No lifting or loss of adhesion |
| 9 | Bright with very | 9 | Lifting or loss of adhesion |
| | slight staining | | up to 0.5 mm |
| 8 | Lustrous with | 8 | Lifting or loss of adhesion |
| | moderate staining | | up to 1.0 mm |
| 7 | Loss of luster, no | 7 | Lifting or loss of adhesion |
| | product build up | | up to 2.0 mm |
| 6 | Heavy staining, minor | 6 | Lifting or loss of adhesion |
| | corrosion no product build up | | up to 3.0 mm |
| 5 | Heavy staining, minor corrosion | 5 | Lifting or loss of adhesion |
| | product build up | | up to 5.0 mm |
| 4 | Moderate corrosion product | 4 | Lifting or loss of adhesion |
| | build up | | up to 7.0 mm |
| 3 | Major corrosion product | 3 | Lifting or loss of adhesion |
| | build up | | up to 10.0 mm |
| 2 | Severe corrosion product | 2 | Lifting or loss of adhesion |
| | build up | | up to 13.0 mm |
| 1 | Complete lifting of coating | 1 | Lifting or loss of adhesion |
| | above rust around scribe | | up to 16.0 mm |
| 0 | Total consumption of coating | 0 | Lifting or loss of adhesion |
| | around scribe | | up to >16.0 mm |

TABLE 5
Corrosion Performance of Examples 1-11 over
Al-2024 after 3,000 hours in B-117 NSF

| | | TCP treated 2024 T3 Bare | | |
|---|---|---|---|---|
| | | Scribe | Scribe Creep | Field |
| Example # | Description | Corrosion | (mm) | Blistering |
| Comp | Untreated Spherical | 40% | 0.1 | 3 |
| Ex 1 | Aluminum Primer | | | |
| Ex 2 | Untreated Spherical | 30% | 0 | 0 |
| | Aluminum Primer with | | | |
| | 20% Aluminum | | | |
| | Hydroxide | | | |
| Ex 3 | Untreated Spherical | 15% | 0.2 | 0 |
| | Aluminum Primer with | | | |
| | 1% Sodium Aluminate | | | |
| Ex 4 | Untreated Spherical | 40% | 0.2 | 0 |
| | Aluminum Primer with | | | |
| | 10% Ferric (III) | | | |
| | Hydroxide | | | |
| Ex 5 | Untreated Spherical | 30% | 0 | 0 |
| | Aluminum Primer with | | | |
| | 3% Ferric (III) Sulfate | | | |
| Ex 6 | Untreated Spherical | 15% | 0 | 0 |
| | Aluminum Primer with | | | |
| | 6% Ferric (III) | | | |
| | Phosphate | | | |
| Comp | TCP Treated Spherical | 30% | 0.2 | 5 |
| Ex 7 | Aluminum Primer | | | |
| Ex 8 | TCP Treated Spherical | 30% | 0 | 3 |
| | Aluminum Primer with | | | |
| | 20% Aluminum | | | |
| | Hydroxide | | | |
| Ex 9 | TCP Treated Spherical | 5% | 0 | 0 |
| | Aluminum Primer with | | | |
| | 1% Sodium Aluminate | | | |
| Comp | Flake Aluminum | 10% | 0 | 0 |
| Ex 10 | Primer | | | |
| Ex 11 | Flake Aluminum | 5% | 0 | 0 |
| | Primer with 20% | | | |
| | Aluminum Hydroxide | | | |

TABLE 6
Corrosion Performance of Examples 7-9 over
Al-2024 after 774 cycles in GMW 14872

| | | TCP treated 2024 T3 Bare | | |
|---|---|---|---|---|
| | | Scribe | Scribe Creep | Field |
| Example # | Description | Corrosion | (mm) | Blistering |
| Comp | TCP Treated Spherical | 30% | 1.8 | 0 |
| Ex 7 | Aluminum Primer | | | |
| Ex 8 | TCP Treated Spherical | 15% | 0.0 | 0 |
| | Aluminum Primer with | | | |
| | 20% Aluminum | | | |
| | Hydroxide | | | |
| Ex 9 | TCP Treated Spherical | 15% | 0.8 | 0 |
| | Aluminum Primer with | | | |
| | 1% Sodium Aluminate | | | |

TABLE 7
Corrosion Performance of Examples 1-6, 10, 11, 13,
and 14 over C700 after 648 hours in B-117 NSF

| | | C700, Zinc Phosphated Cold Rolled Steel | | |
|---|---|---|---|---|
| | | Scribe | Scribe | Field |
| Example # | Description | Appearance | Corrosion | Blisters |
| Comp | Untreated Spherical Aluminum | 3 | 7 | 0 |
| Ex 1 | Primer | | | |
| Ex 2 | Untreated Spherical Aluminum | 5 | 7 | 0 |
| | Primer with 20% Aluminum | | | |
| | Hydroxide | | | |
| Ex 3 | Untreated Spherical Aluminum | 4 | 7 | >5 |
| | Primer with 1% Sodium | | | |
| | Aluminate | | | |
| Ex 4 | Untreated Spherical Aluminum | 5 | 8 | 0 |
| | Primer with 10% Ferric (III) | | | |
| | Hydroxide | | | |
| Ex 5 | Untreated Spherical Aluminum | 3 | 8 | >5 |
| | Primer with 3% Ferric (III) | | | |
| | Sulfate | | | |
| Ex 6 | Untreated Spherical Aluminum | 5 | 8 | 0 |
| | Primer with 6% Ferric (III) | | | |
| | Phosphate | | | |
| Comp | Flake Aluminum Primer | 3 | 7 | >5 |
| Ex 10 | | | | |
| Ex 11 | Flake Aluminum Primer with | 3 | 7 | 0 |
| | 20% Aluminum Hydroxide | | | |
| Ex 13 | Flake Aluminum Primer with | 4 | 8 | 0 |
| | 10% Ferric (III) Hydroxide | | | |
| Ex 14 | Flake Aluminum Primer with | 2 | 8 | 0 |
| | 6% Ferric (III) Phosphate | | | |

TABLE 8
Corrosion Performance of Examples 1-4, 6 and
10-14 over C700 after 27 cycles in GMW 14872

| | | C700, Zinc Phosphated Cold Rolled Steel | | |
|---|---|---|---|---|
| | | Scribe | Scribe | Field |
| Example # | Description | Appearance | Corrosion | Blisters |
| Comp | Untreated Spherical Aluminum | 4 | 6 | 0 |
| Ex 1 | Primer | | | |
| Ex 2 | Untreated Spherical Aluminum | 5 | 7 | 0 |
| | Primer with 20% Aluminum | | | |
| | Hydroxide | | | |
| Ex 3 | Untreated Spherical Aluminum | 5 | 7 | 0 |
| | Primer with 1% Sodium | | | |
| | Aluminate | | | |
| Ex 4 | Untreated Spherical Aluminum | 5 | 8 | 0 |
| | Primer with 10% Ferric (III) | | | |
| | Hydroxide | | | |
| Ex 6 | Untreated Spherical Aluminum | 4 | 7 | 0 |
| | Primer with 6% Ferric (III) | | | |
| | Phosphate | | | |
| Comp | Flake Aluminum Primer | 3 | 6 | 0 |
| Ex 10 | | | | |
| Ex 11 | Flake Aluminum Primer with | 4 | 6 | 0 |
| | 20% Aluminum Hydroxide | | | |
| Ex 12 | Flake Aluminum Primer with | 5 | 7 | 0 |
| | 1% Sodium Aluminate | | | |
| Ex 13 | Flake Aluminum Primer with | 4 | 9 | 0 |
| | 10% Ferric (III) Hydroxide | | | |
| Ex 14 | Flake Aluminum Primer with | 4 | 6 | 0 |
| | 6% Ferric (III) Phosphate | | | |

The B-117, neutral salt fog corrosion data in TABLE 6 clearly shows that film-forming coating composition Examples 2, 3, 4, 5 and 6 containing untreated aluminum powder, a magnesium oxide blend and aluminum salts or iron salts had measurably better corrosion resistance than Comparative Example 1 (containing untreated aluminum powder and magnesium oxide only). TABLE 6 also clearly shows that curable film-forming coating composition Examples 8 and 9 containing TCP treated aluminum powder, a magnesium oxide blend and aluminum salts had measurably better corrosion resistance than Comparative Example 7 (containing TCP treated aluminum powder and magnesium oxide only). And, TABLE 6 clearly shows the curable film-forming coating composition Example 11 containing flake aluminum powder, a magnesium oxide blend and aluminum salt had measurably better corrosion resistance than Comparative Example 10 (containing Flake aluminum powder and magnesium oxide only).

The GMW 14872, cyclic corrosion data in TABLE 7 clearly shows that curable film-forming coating composition Examples 8 and 9 containing TCP treated aluminum powder, a magnesium oxide blend and aluminum salts had measurably better corrosion resistance than Comparative Example 7 (containing TCP treated aluminum powder and magnesium oxide only).

The B-117, neutral salt fog corrosion data in TABLE 8 clearly shows that curable film-forming coating composition Examples 2, 3, 4, 5 and 6 containing untreated aluminum powder, a magnesium oxide blend and aluminum salts or iron salts had measurably better corrosion resistance than Comparative Example 1 (containing untreated aluminum powder and magnesium oxide only). TABLE 8 also clearly shows the curable film-forming coating composition Examples 11, 13, and 14 containing flake aluminum powder, a magnesium oxide blend and aluminum or iron salts had measurably better corrosion resistance than Comparative Example 10 (containing Flake aluminum powder and magnesium oxide only).

The GMW 14872, cyclic corrosion data in TABLE 9 clearly shows that curable film-forming coating composition Examples 2, 3, 4 and 6 containing untreated aluminum powder, a magnesium oxide blend and aluminum salts or iron salts had measurably better corrosion resistance than Comparative Example 1 (containing untreated aluminum powder and magnesium oxide only). TABLE 9 also clearly shows the curable film-forming coating composition Examples 11, 12, 13 and 14 containing flake aluminum powder, a magnesium oxide blend and aluminum or iron salts had measurably better corrosion resistance than Comparative Example 10 (containing flake aluminum powder and magnesium oxide only).

Evidence of these improvements were the enhanced scribe appearance, reduced scribe corrosion, and/or lessening of blistering around the scribe or on the field.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A coated metal substrate comprising:
a metal substrate; and
a coating applied over at least a portion of the metal substrate, wherein the coating comprises a film-forming binder; magnesium oxide; an aluminum compound and/or iron compound; and aluminum particles.

2. The coated metal substrate of claim 1, wherein the coating has a thickness of at least 10 microns.

3. The coated metal substrate of claim 1, wherein the magnesium oxide and the aluminum and/or iron compound are present in a weight ratio of 1:1 to 240:1.

4. (canceled)

5. The coated metal substrate of claim 1, wherein the aluminum compound and/or iron compound comprises a water-soluble aluminum compound and/or a water-soluble iron compound.

6. The coated metal substrate of claim 1, wherein the iron compound comprises iron phosphate, iron sulfate, and/or iron hydroxide.

7. The coated metal substrate of claim 1, wherein the aluminum compound comprises an alkali aluminate, aluminum hydroxide, and/or aluminum phosphate.

8. The coated metal substrate of claim 1, wherein the magnesium oxide has a particle size of at least 20 nm, as measured using an aqueous dispersion adjusted to a solid MgO concentration of 0.1% by weight with ion exchange water and measured by laser light scattering particle distributor, Coulter model N4 (manufactured by Coulter) at 20° C.

9-12. (canceled)

13. The coated metal substrate of claim 1, wherein the coating comprises a pigment component comprising the magnesium oxide, the aluminum compound and/or the iron compound, the aluminum particles, and optionally further comprising a secondary pigment, wherein the magnesium oxide is present in an amount of 10% to 95% by weight, the aluminum compound and/or the iron compound is present in an amount of 0.05% to 35% by weight, and the aluminum particles are present in an amount of 5% to 90% by weight, based on the total weight of the pigment component.

14. (canceled)

15. The coated metal substrate of claim 1, wherein the metal substrate comprises a ferrous substrate, an aluminum substrate, or an aluminum alloy substrate.

16. The coated metal substrate of claim 1, wherein the metal substrate comprises a ferrous substrate and the coating comprises the iron compound.

17. The coated metal substrate of claim 1, wherein the metal substrate comprises a ferrous substrate and the coating comprises the aluminum compound.

18. The coated metal substrate of claim 1, wherein the metal substrate comprises an aluminum substrate or an aluminum alloy substrate and the coating comprises the iron compound.

19. The coated metal substrate of claim 1, wherein the metal substrate comprises an aluminum substrate or an aluminum alloy substrate and the coating comprises the aluminum compound.

20-25. (canceled)

26. A curable film-forming coating composition comprising:
a film-forming binder;
magnesium oxide;
an aluminum and/or iron compound; and
aluminum particles.

27-30. (canceled)

31. The curable film-forming coating composition of claim 26, wherein the iron compound comprises iron phosphate, iron sulfate, and/or iron hydroxide.

32. The curable film-forming coating composition of claim 26, wherein the aluminum compound comprises an alkali aluminate, aluminum hydroxide, and/or aluminum phosphate.

33. The curable film-forming coating composition of claim 26, wherein the magnesium oxide has a particle size of at least 20 nm, as measured using an aqueous dispersion adjusted to a solid MgO concentration of 0.1% by weight with ion exchange water and measured by laser light scattering particle distributor, Coulter model N4 (manufactured by Coulter) at 20° C.

34-39. (canceled)

40. A method of coating a metal substrate comprising applying the curable film-forming coating composition of claim 26 to at least a portion of the substrate to form a coating.

41. The method of claim 40, wherein the coating has a dry film thickness of at least 10 microns.

42. (canceled)

43. A coated substrate, wherein the coated substrate is at least partially coated with the curable film-forming coating composition of claim 26.

44-48. (canceled)
